(19) United States
(12) Patent Application Publication
(10) Pub. No.: US 2022/0352751 A1
(43) Pub. Date: Nov. 3, 2022

(54) SIGNALING FOR ENERGY HARVESTING

(71) Applicant: QUALCOMM Incorporated, San Diego, CA (US)

(72) Inventors: Ahmed ELSHAFIE, San Diego, CA (US); Alexandros MANOLAKOS, Escondido, CA (US); Sony AKKARAKARAN, Poway, CA (US); Seyedkianoush HOSSEINI, San Diego, CA (US)

(21) Appl. No.: 17/661,424

(22) Filed: Apr. 29, 2022

Related U.S. Application Data
(60) Provisional application No. 63/201,495, filed on Apr. 30, 2021.

(51) Int. Cl. H02J 50/00; H02J 50/23; H02J 50/80

(52) U.S. Cl. CPC H02J 50/001; H02J 50/23; H02J 50/80

(57) ABSTRACT

Wireless communications systems and methods related to energy harvesting services are provided. A first wireless communication device transmitting, to a second wireless communication device, at least one of an energy request or an energy level indication. The first wireless communication device receives, from the second wireless communication device in response to the at least one of the energy request or the energy level indication, an indication of one or more resources for receiving a radio frequency (RF) energy harvesting signal. The first wireless communication device receives, from the second wireless communication device in the one or more resources, the RF energy harvesting signal. The first wireless communication device converts the RF energy harvesting signal to energy.

### CROSS REFERENCE TO RELATED APPLICATIONS & PRIORITY CLAIM

The present application claims priority to and the benefit of the U.S. Provisional Patent Application No. 63/201,495, filed Apr. 30, 2021, which is hereby incorporated by reference in its entirety as if fully set forth below and for all applicable purposes.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

Energy harvesting is a technique to collect energy from local, surrounding environments. Energy can be harvested from a wide variety of sources, such as solar, wind, thermal, piezoelectric, and/or radio frequency (RF) energy sources. Energy harvesting can be used to increase the lifespan of batteries in low-power devices and/or enable deployments of battery-less wireless communication devices. As use cases and diverse deployment scenarios continue to expand in wireless communication, for example, for low-power devices such as Internet of Things (IoT) devices, energy harvesting procedural and/or technique improvements may also yield benefits.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects of the present disclosure include mechanisms for provisioning wireless radio frequency (RF) energy harvesting services in a wireless communication network. Certain aspects described herein allows a first wireless communication device to request for energy, for example, from a second wireless communication device. The first wireless communication device may include an energy harvester (e.g., an RF signal to direct current (DC) conversion component or circuitry). Additionally or alternatively, the first wireless communication device may report an energy level (e.g., a remaining battery energy level) of the energy harvesting device to the second wireless communication device. Further, in response to the energy request and/or energy level indication, the second wireless communication device may allocate one or more resources (e.g., including one or more symbols in time or one or more subcarriers in frequencies) for transmitting an RF signal to the first wireless communication device for energy harvesting. Subsequently, the second wireless communication device may transmit, and the first wireless communication device may receive, a schedule indicating the one or more allocated resources. The second wireless communication device may transmit, and the first wireless communication device may receive, the RF signal for energy harvesting in the one or more allocated resources. Upon receiving the RF signal, the first wireless communication device may convert, using the energy harvester, the received RF signal into energy for functional operations (e.g., signal processing, data encoding, data decoding, data transmission, and/or data reception).

In one aspect of the disclosure, a method of wireless communication performed by a first wireless communication device includes to a second wireless communication device, at least one of an energy request or an energy level indication; receiving, from the second wireless communication device in response to the at least one of the energy request or the energy level indication, an indication of one or more resources for receiving a radio frequency (RF) energy harvesting signal; receiving, from the second wireless communication device in the one or more resources, the RF energy harvesting signal; and converting the RF energy harvesting signal to energy.

In an additional aspect of the disclosure, a method of wireless communication performed by a first wireless communication device includes receiving, from a second wireless communication device, at least one of an energy request or an energy level indication; transmitting, to the second wireless communication device in response to the at least one of the energy request or the energy level indication, an indication of one or more resources for transmitting a radio frequency (RF) energy harvesting signal; and transmitting, to the second wireless communication device in the one or more resources, the RF energy harvesting signal.

In an additional aspect of the disclosure, a first wireless communication device includes a memory; a transceiver; an energy harvester; and at least one processor coupled to the memory, the transceiver, and the energy harvester, where first wireless communication device is configured to transmit, to a second wireless communication device via the transceiver, at least one of an energy request or an energy level indication; receive, from the second wireless communication device via the transceiver in response to the at least one of the energy request or the energy level indication, an indication of one or more resources for receiving a radio frequency (RF) energy harvesting signal; receive, from the second wireless communication device in the one or more resources via the transceiver, the RF energy harvesting signal; and converting, at the energy harvester, the RF energy harvesting signal to energy.

In an additional aspect of the disclosure, a first wireless communication device includes a memory; a transceiver; and at least one processor coupled to the memory and the transceiver, where first wireless communication device is configured to receive, from a second wireless communication device via the transceiver, at least one of an energy request or an energy level indication; transmit, to the second wireless communication device via the transceiver in response to the at least one of the energy request or the energy level indication, an indication of one or more resources for transmitting a radio frequency (RF) energy harvesting signal; and transmit, to the second wireless communication device in the one or more resources via the transceiver, the RF energy harvesting signal.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frequency (RF) energy harvesting scenario according to some aspects of the present disclosure.

FIG. 3 illustrates a wireless communication device implementing RF energy harvesting according to some aspects of the present disclosure.

FIG. 4 illustrates an RF energy harvesting scheme according to some aspects of the present disclosure.

FIG. 5 illustrates an RF energy harvesting scheme according to some aspects of the present disclosure.

FIG. 6 illustrates an RF energy harvesting scheme according to some aspects of the present disclosure.

FIG. 7 is a signaling diagram illustrating an RF energy harvesting service provisioning method according to some aspects of the present disclosure.

FIG. 8 is a signaling diagram illustrating an RF energy harvesting service provisioning method according to some aspects of the present disclosure.

FIG. 9 is a signaling diagram illustrating an RF energy harvesting service provisioning method according to some aspects of the present disclosure.

FIG. 10 is a signaling diagram illustrating an RF energy harvesting service provisioning according to some aspects of the present disclosure.

FIG. 11 illustrates a block diagram of a base station (BS) according to some aspects of the present disclosure.

FIG. 12 illustrates a block diagram of a user equipment (UE) according to some aspects of the present disclosure.

FIG. 13 is a flow diagram of a wireless communication method according to some aspects of the present disclosure.

FIG. 14 is a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ˜1M nodes/km²), ultra-low complexity (e.g., ˜10s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW. In certain aspects, frequency bands for 5G NR are separated into multiple different frequency ranges, a frequency range one (FR1), a frequency range two (FR2), and FR2x. FR1 bands include frequency bands at 7 GHz or lower (e.g., between about 410 MHz to about 7125 MHz). FR2 bands include frequency bands in mmWave ranges between about 24.25 GHz and about 52.6 GHz. FR2x bands include frequency bands in mmWave ranges between about 52.6 GHz to about 71 GHz. The mmWave bands may have a shorter range, but a higher bandwidth than the FR1 bands. Additionally, 5G NR may support different sets of subcarrier spacing for different frequency ranges.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

While energy can be harvested from a wide variety of sources, such as solar, wind, thermal, piezoelectric, and/or radio frequency (RF) energy sources, RF energy harvesting may provide several advantages over the other energy sources. For instance, energy that can be harvested from an RF energy source may be dependent on the power of the RF source and the distance between the RF source and a corresponding RF receiver harvesting the energy. Thus, RF energy sources can provide controllable and constant energy transfer over distance for RF energy harvesters. In a fixed RF-energy harvesting network, where network nodes are relatively stationary, the amount of energy that can be harvested may be predictable and relatively stable over time due to the fixed distance between nodes that provisions for energy through RF wireless signal transmissions and nodes that harvest the energy.

In certain aspects, a wireless communication device can harvest energy from radio frequency (RF) signals, for example, transmitted by a serving BS or another wireless communication device. Energy harvested from the RF signals can be accumulated over time and stored at the wireless communication device. The wireless communication device can perform operations, such as signal processing operations, data encoding and/or decoding, data transmission and/or reception, using the accumulated/stored energy obtained from energy harvesting.

As used herein, the term “energy harvesting device” may refer to a wireless communication device or a receiver that receives RF signals and convert the received RF signals into energy for functional operations (e.g., signal processing, data processing, data encoding, data decoding, data transmission, and/or data reception) at the device. In some instances, an energy harvesting device may be a lower-power device, a sensor, a wearable, an IoT device, or any wireless communication device that is equipped with an energy harvesting circuitry that can covert RF power or alternate current (AC) to direct current (DC) power. As used herein, the term “energy provisioning device” may refer to a wireless communication device or transmitter that transmit RF signals to a wireless communication device or receiver to enable energy harvesting from the RF signals. In some instances, an energy provisioning device may be a base station (BS), a network controller, a UE that operates as a relay between a BS and a wireless communication device, or a UE controller that controls sidelink communication. In some aspects, a wireless communication device may function as an energy harvest device at one time, and may function as an energy provisioning device at another time.

The present disclosure describes mechanisms for provisioning RF energy harvesting services. For example, a first wireless communication device may be an energy harvesting device including an energy harvester (e.g., energy harvesting circuitry) and a second wireless communication device may function as an energy provisioning device. The first wireless communication device may transmit an energy request, for example, autonomously, to the second wireless communication device. In some aspects, the first wireless communication device may be a UE, and the second wireless communication device may be a B S. In other aspects, the first wireless communication device may be a UE, and the second wireless communication device may be another UE. The energy request may indicate a request for an energy harvesting service from the second wireless communication device. In response, the second wireless communication device may allocate one or more resources (e.g., each including one or more symbols in time and one or more subcarriers in frequency) for transmitting an RF signal to the first wireless communication device for energy harvesting. The second wireless communication device may transmit an indication of the one or more allocated resources (e.g., a transmission schedule for an RF energy harvesting signal) to the first wireless communication device. The first wireless communication device may monitor for an RF energy harvesting signal reception schedule and may receive the indication of the one or more allocated resources. Subsequently, the second wireless communication device may transmit, and the first wireless communication device may receive, an RF energy harvesting signal in the one or more allocated resources. The first wireless communication device may convert the received RF energy harvesting signal to energy, for example, utilizing the energy harvesting circuitry. The first wireless communication device may utilize the harvested energy for current operations (e.g., immediate use) and/or store the harvested energy (e.g., a battery) for use at a later point of time.

In some aspects, the second wireless communication device may configure the first wireless communication device with a configuration (e.g., a radio resource control (RRC) configuration) for a window or a duration of multiple occasions (e.g., user-assistance information signaling occasions) for transmitting an energy request. Accordingly, the first wireless communication device may transmit, and the second wireless communication device may receive, the energy request in one of the occasions. In other aspects, the second wireless communication device may configure the first wireless communication device with a configuration (e.g., an RRC configuration) for a configured grant resource for transmitting an energy request. Accordingly, the first wireless communication device may transmit, and the second wireless communication device may receive, the energy request in the configured grant resource.

In some aspects, the first wireless communication device may further indicate a required or requested energy harvesting duration to the second wireless communication device. The indication of the energy harvesting duration may be in units of symbols (e.g., OFDM symbols). In some aspects, the first wireless communication device may determine the energy harvesting duration based on at least one of an energy harvesting rate, a number of tasks (to be powered by harvested energy), a reference transmit power (e.g., a transmit power used by the second wireless communication device for transmitting RF signals for energy harvesting), a channel parameter (e.g., a channel coefficient for a link between the first wireless communication device and the second wireless communication device), or a radio frequency-to-energy conversion parameter (e.g., provided by the energy harvesting circuitry).

In some aspects, instead of the first wireless communication device (the energy harvesting device) requesting for energy, the second wireless communication device (the energy provisioning device) may initiate an energy harvesting device for the first wireless communication device. For instance, the first wireless communication device may transmit an energy level indication, for example, indicating a remaining battery level, to the second wireless communication device. The second wireless communication device may determine whether to initiate an energy harvesting service for the first wireless communication device by comparing the indicated energy level to a threshold. For instance, if the indicated energy level is below the threshold, the second wireless communication device may initiate the energy harvesting service. If, however, the indicated energy level is above the threshold, the second wireless communication device may not initiate the energy harvesting service. In some aspects, the second wireless communication device may request the first wireless communication device to indicate an energy harvesting duration (e.g., a duration for accumulating energy at the wireless communication device), which may correspond to a desired or requested amount of energy to be harvested. Further, in some aspects, the second wireless communication device may determine a resource size (e.g., a number of symbols) for the one or more resources according to the indicated energy harvesting duration.

In some aspects, the second wireless communication device may reduce the amount of data transmission and/or receptions scheduled for the first wireless communication device upon receiving an energy request or a low energy level indication (e.g., below a threshold) from the wireless communication device.

In some aspects, the first wireless communication device may enter a sleep mode after transmitting the energy request or the energy level indication, for example, to save power when the first wireless communication device may have a limited amount of remaining battery power. The second wireless communication device may determine a schedule (e.g., the one or more resources) for transmitting the RF energy harvesting signal to the first wireless communication device. Since the first wireless communication device is operating in a sleep mode, the second wireless communication device may transmit a wake-up signal (WUS) to the first wireless communication device before transmitting the indication of the one or more resources to the first wireless communication device. Accordingly, upon detecting the WUS, the first wireless communication device may transition from the sleep mode to an active mode and may receive the indication of the one or more resources allocated for communicating the RF energy harvesting signal.

Aspects of the present disclosure can provide several benefits. For example, the present disclosure provides flexibility for an energy harvesting device to initiate an energy harvesting service or for an energy provisioning device to initiate an energy harvesting service. Additionally, the present disclosure provides techniques for an energy harvesting device to assist an energy provisioning device in scheduling an appropriate amount of resources for transmitting RF signal for energy harvesting, for example, by providing an energy harvest time duration indication and/or energy level indication to the energy provisioning device. Further, allowing energy harvesting device to enter a sleep mode after requesting for energy or reporting an energy level allows the energy harvesting device already having a low energy level to conserve power. The present disclosure may be suitable for use in any wireless communication networks or energy networks and/or with any wireless communication protocols.

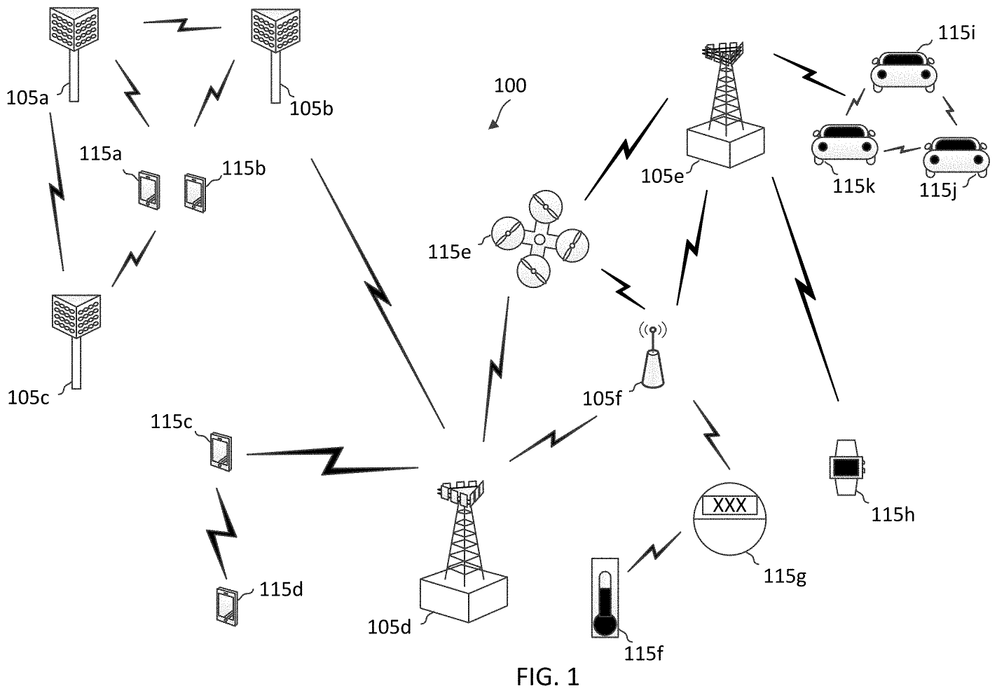

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. ABS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

ABS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using hybrid automatic repeat request (HARD) techniques to improve communication reliability, for example, to provide a ultra-reliable, low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. The goal of LBT is to protect reception at a receiver from interference. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

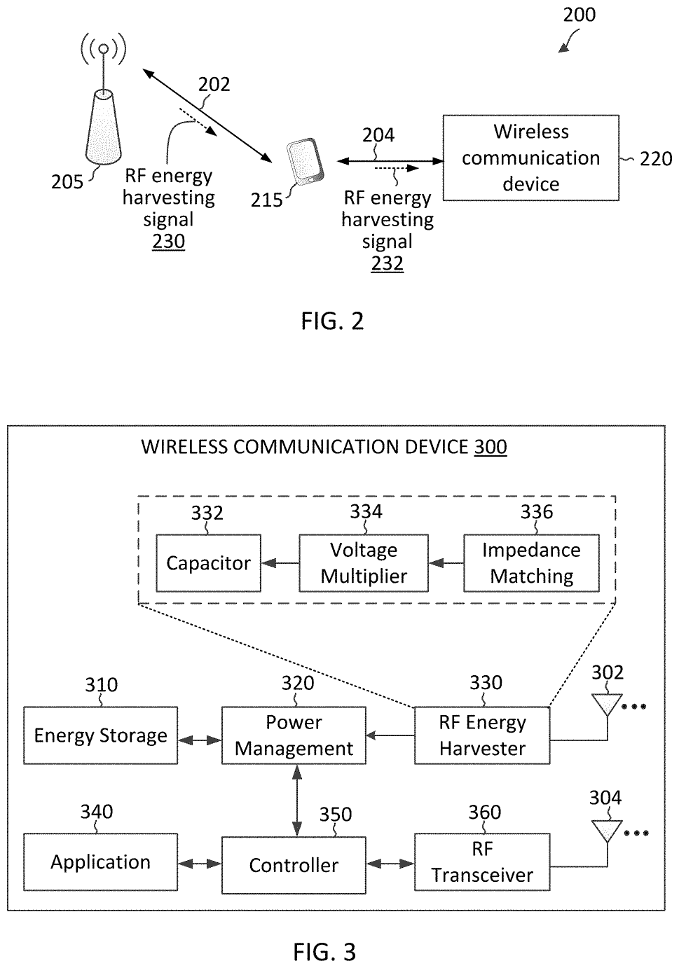

In some aspects, the network 100 may provision for sidelink communications to allow a UE 115 to communicate with another UE 115 without tunneling through a BS 105 and/or the core network as shown in FIG. 2. Sidelink communication can be communicated over a physical sidelink control channel (PSCCH) and a physical sidelink shared channel (PSSCH). For instance, the PSCCH may carry sidelink control information (SCI) and the PSSCH may carry SCI and/or sidelink data (e.g., user data). Each PSCCH is associated with a corresponding PSSCH, where SCI in a PSCCH may carry reservation and/or scheduling information for sidelink data transmission in the associated PSSCH. In some examples, a sidelink UE 115 may transmit a sidelink transmit a sidelink transmission including SCI in two stages. In a first-stage SCI (which may be referred to as SCI-1), the UE 115 may transmit SCI in PSCCH carrying information for resource allocation and decoding a second-stage SCI. The first-stage SCI may include at least one of a priority, PSSCH resource assignment, resource reservation period (if enabled), PSSCH demodulation reference signal (DMRS) pattern (if more than one pattern is configured), a second-stage SCI format (e.g., size of second-stage SCI), an amount of resources for the second-stage SCI, a number of PSSCH demodulation reference signal (DMRS) port(s), a modulation and coding scheme (MCS), etc. In a second-stage SCI (which may be referred to as SCI-2), the UE 115 may transmit SCI in PSSCH carrying information for decoding the PSSCH. The second-stage SCI may include an 8-bit layer 1 (L1) destination identifier (ID), an 8-bit L1 source ID, a HARQ process ID, a new data indicator (NDI), a redundancy version (RV), etc. It should be understood that these are examples, and the first-stage SCI and/or the second-stage SCI may include or indicate additional or different information than those examples provided. Sidelink communication can also be communicated over a physical sidelink feedback control channel (PSFCH), which indicates an ACK or an NACK for a previously transmitted PSSCH.

In some aspects, the network 100 may operate over a mmWave band (e.g., at 60 GHz). Due to the high pathloss in the mmWave band, the BSs 105 and the UEs 115 may utilize directional beams to communicate with each other. For instance, a BS 105 and/or a UE 115 may be equipped with one or more antenna panels or antenna arrays with antenna elements that can be configured to focus transmit signal energy and/or receive signal energy in a certain spatial direction and within a certain spatial angular sector or width. In general, a BS 105 and/or a UE 115 may be capable of generating a transmission beam for transmission or a reception beam for reception in various spatial direction or beam directions.

As used herein, the term “transmission beam” may refer to a transmitter transmitting a beamformed signal in a certain spatial direction or beam direction and/or with a certain beam width covering a certain spatial angular sector. The transmission beam may have characteristics such as the beam direction and the beam width. The term “reception beam” may refer to a receiver using beamforming to receive a signal from a certain spatial direction or beam direction and/or within a certain beam width covering a certain spatial angular sector. The reception beam may have characteristics such as the beam direction and the beam width.

In some aspects, the network 100 may be a self-sustainable network, where nodes or UEs 115 in the network 100 may communicate or interact with each other using energy harvested through RF signal transmissions in the network 100. Mechanisms for provisioning for RF energy harvesting services are described in greater detail herein.

FIG. 2 illustrates an RF energy harvesting scenario 200 according to some aspects of the present disclosure. The RF energy harvesting scenario 200 may correspond to an RF energy harvesting scenario among BSs 105 and or UEs 115 in the network 100. For simplicity, FIG. 2 illustrates one BS 205 and two wireless communication device 215s and 220, but a greater number of BSs 205 (e.g., 2, 3, 4 or more) and/or a greater number of wireless communication devices 220 (e.g., about 2, 3, 4, 5, 6, 7, 8 or more) may be supported. The BS 205 may be similar to the BSs 105, and the wireless communication devices 215 and 220 may be similar to the UEs 115. The wireless communication device 215 may be within a coverage of the BS 205 and may be served by the BS 205 over a direct link 202 (e.g., a Uu interface), whereas the wireless communication device 220 may be out of the coverage of the BS 205. The wireless communication device 220 may be in communication with the wireless communication device 215 over a sidelink 204 (e.g., PC5 interface). The wireless communication device 215 may operate as a relay between the BS 205 and the wireless communication device 220. In some aspects, the wireless communication device 220 may be more limited in power and/or in capabilities (e.g., in terms of data rates, processing, and/or 5G functionalities) compared to the wireless communication device 215. In some aspects, the wireless communication device 220 may be an IoT device (e.g., sensors, actuators, machines, etc.). In some aspects, the wireless communication device 220 may be a wearable (e.g., a smart-watch, an activity tracker, a health monitoring device) connected to the wireless communication device 215 (which may be a smartphone). In some aspects, the wireless communication device 220 may be an extended-reality (XR) head-mounted-display (HMD) connected to the wireless communication device 215. In some aspects, the wireless communication device 220 may be a sensor, for example, in a home appliance. In some aspects, the wireless communication device 215 may be connected to multiple wireless communication devices 220 via sidelinks, and may operate as a sidelink controller to control and/or facilitate communications among the wireless communication devices in a mesh topology, for example, in a smart home or a smart energy network.

In some aspects, the wireless communication device 215 may include an energy harvester (e.g., the energy harvester module 330 of FIG. 3) that can harvest energy from RF signals. For instance, the serving BS 205 may transmit an RF energy harvesting signal 230 via the link 202 to facilitate energy harvesting at the wireless communication device 215. The RF energy harvesting signal 230 may be at any suitable RF frequency and may occupy any suitable frequency bandwidth. The BS 205 may transmit the RF energy harvesting signal 230 using any suitable transmit power and over any suitable time duration. The wireless communication device 215 may receive the RF energy harvesting signal 230, convert the RF energy harvesting signal 230 into energy, and utilize the energy harvested from the RF energy harvesting signal 230 for various operations, such as signal processing operations, data encoding, data decoding, data transmission, and data receptions, at the wireless communication device 215.

In some aspects, the wireless communication device 220 may include an energy harvester (e.g., the energy harvester module 330 of FIG. 3) that can harvest energy from RF signals. For instance, the wireless communication device 215 may transmit an RF energy harvesting signal 232 via the sidelink 204 to enable energy harvesting at the wireless communication device 220. Similar to the RF energy harvesting signal 230, the RF energy harvesting signal 232 may be at any suitable RF frequency and may occupy any suitable frequency bandwidth. The wireless communication device 215 may transmit the RF energy harvesting signal 232 using any suitable transmit power and over any suitable time duration. The wireless communication device 220 may receive the RF energy harvesting signal 232, convert the RF energy harvesting signal 232 into energy, and utilize the energy harvested from the RF energy harvesting signal 232 for various operations, such as signal processing operations, data encoding, data decoding, data transmission, and data receptions, at the wireless communication device 220.

While FIG. 2 illustrates the wireless communication device 215 harvesting energy from the RF energy harvesting signal 230 transmitted by the BS 205, and the wireless communication device 220 harvesting energy from the RF energy harvesting signal 232 transmitted by the wireless communication device 215, aspects are not limited thereto. For instance, in some aspects, the wireless communication device 215 may harvest energy from the RF energy harvesting signal 230 transmitted by the BS 205, but the wireless communication device 220 may not harvest energy from RF transmissions of the wireless communication device 215. In other aspects, the wireless communication device 220 may harvest energy from the RF energy harvesting signal 232 transmitted by the wireless communication device 215, but the wireless communication device 215 may not harvest energy from RF transmissions of the BS 205.

The wireless communication device 215 and/or the wireless communication device 220 may utilize a variety of receiver architectures to receive the RF energy harvesting signal 230 and/or the RF energy harvesting signal 232, respectively. The RF energy harvesting signal 230 may or may not include useful data information depending on the receiver architecture at the wireless communication device 215. Similarly, the RF energy harvesting signal 232 may or may not include useful data information depending on the receiver architecture of the wireless communication device 220. Various receiver architectures are discussed below with reference to FIGS. 3-6.

FIG. 3 illustrates a wireless communication device 300 implementing RF energy harvesting according to some aspects of the present disclosure. The wireless communication device 300 may correspond to a UE 115, a wireless communication device 215, or a wireless communication device 220. The wireless communication device 300 may include an energy storage module 310, a power management module 320, an RF energy harvester module 330, an application module 340, a controller module 350, an RF transceiver 360, and RF antennas 302 and 304.

The RF energy harvester module 330 may be coupled to the antenna 302. The RF energy harvester module 330 may include hardware and/or software components configured to receive RF signals (e.g., RF energy harvesting signal 230 and/or 232) from the RF antenna(s) 302 and covert the received RF signals into energy. The harvested energy can be used for operations (e.g., signal processing operations, data encoding, data decoding, data transmission, and data receptions) at the wireless communication device 300. In the illustrated example of FIG. 3, the energy harvester module 330 may include an impedance matching module 336, a voltage multiplier module 334, and a capacitor module 332. In some aspects, the impedance matching module 336 may include an impedance matching circuit (e.g., including inductors and/or capacitors) to provide a maximum transfer of RF signal energy to the voltage multiplier module 334. The voltage multiplier module 334 may include a rectifier circuit that converts alternate current (AC) input to direct current (DC) output. The capacitor module 332 may include one or more capacitors that hold the DC charge (the harvested energy) output by the voltage multiplier module 334.

The power management module 320 may be coupled to the RF energy harvester module 330 and the controller module 350. The power management module 320 may include hardware and/or software components configured to determine whether to store and accumulate the harvested energy at the energy storage module 310 and/or provide the harvested energy to the controller module 350 and/or the RF transceiver 360 for current processing (e.g., signal processing operations, data encoding, data decoding, data transmission, and data receptions). The energy storage module 310 may be coupled to the power management module 320 and may be configured to store and accumulate the harvested energy for use at a later time. In some aspects, the energy storage module 310 may be a battery, for example.

The RF transceiver 360 may be coupled to the RF antennas 304. The RF transceiver 360 may include hardware and/or software components configured to encode and/or modulate data for RF transmissions over the air via the RF antennas 304, receive RF signals over the air via the RF antennas 304, and/or demodulate and/or decode data from the received RF signals.

The controller module 350 may be coupled to the power management module 320, the RF transceiver 360, and the application module 340. In some aspects, the controller module 350 may include one or more general processors, one or more digital signal processor (DSP), one or more application specific integrated circuit (ASIC), one or more field programmable gate array (FPGA) devices, or one or more micro-controllers that process data and/or control operations at the wireless communication device 300.

The application module 340 may include hardware and/or software components configured to perform various operations for specific applications (e.g., sensor applications, medical monitoring, smart energy applications, IoT applications, etc.).

In general, the wireless communication device 300 may or may not receive any other input power. Moreover, at least some operations performed by the RF transceiver 360, the controller module 350, and/or the application module 340 can be powered by energy harvested from the RF energy harvester module 330.

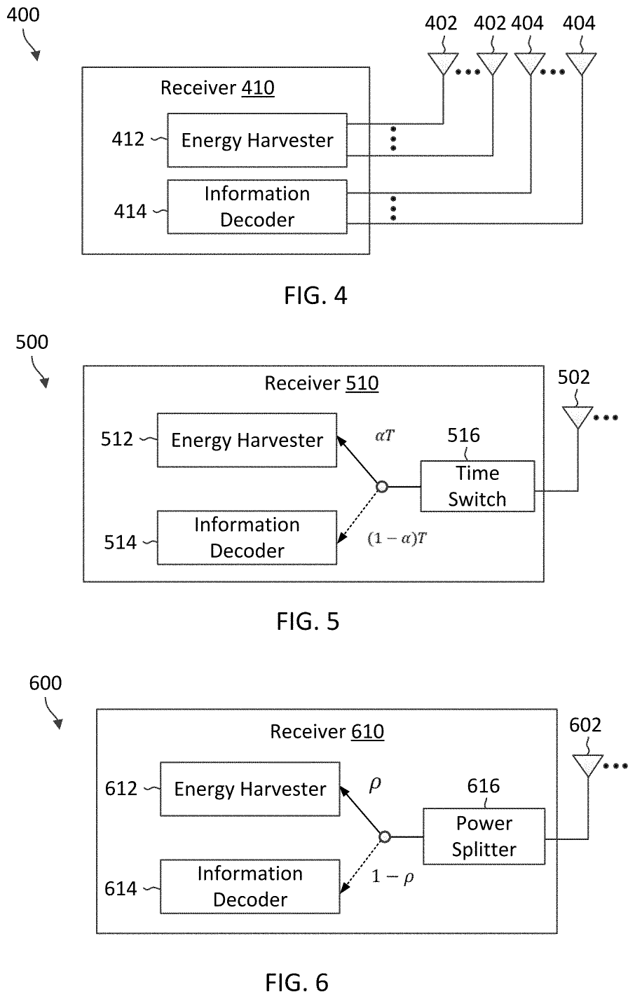

FIGS. 4-6 illustrate various RF energy harvesting techniques that may be utilized by an energy harvesting device (e.g., the UEs 115 and/or wireless communication devices 215, 220, and/or 300). In some aspects, an energy harvesting device may utilize one RF receive antenna chain (including one or more receive antenna elements, antenna arrays, and/or antenna panels) for receiving RF signals for energy harvesting and a separate RF receive antenna chain for receiving data information as described below in FIG. 4. In other aspects, an energy harvesting device may utilize a time-switching receiver architecture that switches a single RF receive antenna chain between receiving RF signals for energy harvesting and receiving data information as described below in FIG. 5. In yet other aspects, an energy harvesting device may utilize a power-split receiver architecture that can divide an RF signal carrying information received from a single RF receive antenna chain into two portions, one for energy harvesting and the other one for data decoding as described below in FIG. 6.

FIG. 4 illustrates an RF energy harvesting scheme 400 according to some aspects of the present disclosure. The scheme 400 may be employed by a wireless communication device such as the UEs 115 and/or wireless communication devices 215, 220, and/or 300. In particular, a wireless communication device may implement a receiver with separate RF receive antenna chains for RF energy harvesting and data reception as shown in the scheme 400. In the scheme 400, a receiver 410 may include an energy harvester module 412 and an information decoder module 414. The energy harvester module 412 and the information decoder module 414 may be coupled to different RF receive antennas. In the illustrated example of FIG. 4, the energy harvester module 412 may be coupled to one or more receive antennas 402, and the information decoder module 414 may be coupled to one or more receive antennas 404 separate from the receive antennas 402.

The energy harvester module 412 may be similar to the energy harvester module 330. The energy harvester module 412 may include hardware and/or software components configured to receive RF signals (e.g., RF energy harvesting signal 230 and/or 232) from the receive antennas 402 and convert the received RF signals to energy as discussed above with reference to FIG. 3. The information decoder module 414 may include hardware and/or software components configured to receive RF signals carrying information data (useful information) from the receive antennas 404 and decode the information data from the received RF signals. In some aspects, since the RF receive antennas 402 (for receiving RF energy harvesting signals) are separate from the RF receive antennas 404 (for receiving data carrying RF signals), the energy harvester module 412 may receive RF signals for energy harvesting at the same time as the information decoder module 414 receiver RF signals carrying information data. In other words, a transmitting node (e.g., the BSs 105 and/or 205, the UEs 115, and/or the wireless communication devices 215, 220, and/or 300) in communication with the receiver 410 may transmit an RF signal for energy harvesting concurrent with an RF signal carrying data information to the receiver 410.

In some aspects, when a wireless communication device (e.g., the UEs 115 and/or the wireless communication devices 215, 220, and/or 300), denoted as node j, utilizes the scheme 400, energy harvested by node j from a transmitting node i (an energy provisioning device) can be computed using a random multipath fading channel model as shown below:

Eⱼ=η×Pᵢ×|gᵢ₋ⱼ|²×T, (1)

where Eⱼ represents the amount of harvested energy; η represents a radio frequency-to-direct current (RF-to-DC) conversion efficiency of an energy harvester (e.g., the RF energy harvester modules 330 and/or 410) at node j, Pᵢ represents the transmit power at the transmitting node i, |gᵢ₋ⱼ|² represents the channel coefficient of the link (e.g., the links 202 and/or 204) between node i and node j, and T represents the time duration allocated for energy harvesting. That is, Eⱼ represents the amount of energy harvested over the time duration T, where Eⱼ may be in units of Joules or micro-Joules. In some aspects, the RF-to-DC conversion efficiency η may be between 0 and 1. In some aspects, the RF-to-DC conversion efficiency η may be close to 1.

FIG. 5 illustrates an RF energy harvesting scheme 500 according to some aspects of the present disclosure. The scheme 500 may be employed by a wireless communication device such as the UEs 115 and/or wireless communication devices 215, 220, and/or 300. In particular, a wireless communication device may implement a receiver with a single RF receive antenna chain switching between receiving RF signals for energy harvesting and receiving data information as shown in the scheme 500. In the scheme 500, a receiver 510 may include an energy harvester module 512, an information decoder module 514, and a time switch module 516. The energy harvester module 512 and the information decoder module 514 may be coupled to the same RF receive antenna(s) 502 via the time switch module 516.

The time switch module 516 may include hardware and/or software components configured to switch the connection to the RF receive antennas 502 between the energy harvester module 512 and the information decoder module 514. For instance, for a certain time duration T, the energy harvester module 512 may be connected to the RF receive antennas 502 for a time duration α×T, and the information decoder module 514 may be connected to the RF receive antennas 502 for a remaining time duration (1−α)×T as shown, where 0≤α≤1 represents the fraction of time allocated for energy harvesting.

The energy harvester module 512 may be similar to the energy harvester modules 330 and 412. The energy harvester module 512 may include hardware and/or software components configured to receive RF signals from the receive antennas 502 (for the time duration α×T) and convert the received RF signals to energy as discussed above with reference to FIG. 3. The information decoder module 414 may include hardware and/or software components configured to receive RF signals carrying information data (useful information) from the receive antennas 502 (for the time duration (1−α)×T) and decode the information data from the received RF signals. Accordingly, a transmitting node (e.g., the BSs 105 and/or 205, the UEs 115 and/or the wireless communication devices 215, 220 and/or 300) in communication with the receiver 510 may transmit an RF signal for energy harvesting and an RF signal carrying data information to the receiver 510 at different times.

In some aspects, when a wireless communication device (e.g., the UEs 115 and/or the wireless communication devices 215, 220, and/or 300), denoted as node j, utilizes the scheme 500, energy harvested by node j from a transmitting node i (an energy provisioning device) can be computed using a random multipath fading channel model as shown below:

Eⱼ=η×Pᵢ×|gᵢ₋ⱼ|²×α×T. (2)

The data rate that can be achieved at node j can be represented by the following relationship:

$${R}_{i - j} = ( 1 - α ) \times {log}_{2} ( 1 + \frac{{\vert {g}_{i - j} \vert}^{2} \times {P}_{i}}{κ \times W} ) , \qquad ( 3 )$$

here Rᵢ₋ⱼ represents the data rate, κ represents the noise spectral density in the channel, and W represents the channel bandwidth used for communicating data.

FIG. 6 illustrates an RF energy harvesting scheme according to some aspects of the present disclosure. The scheme 600 may be employed by a wireless communication device such as the UEs 115 and/or wireless communication device 215, 220, and/or 300. In particular, a wireless communication device may implement a receiver with a single RF receive antenna chain and provides a portion of a received signal for energy harvesting and another portion of the received signal for information decoding as shown in the scheme 600. In the scheme 600, a receiver 610 may include an energy harvester module 612, an information decoder module 614, and a power splitter module 616. The energy harvester module 612 and the information decoder module 614 may be coupled to the same RF receive antenna(s) 602 via the power splitter module 616.

The power splitter module 616 may include hardware and/or software components configured to split an RF signal received from the RF receive antenna(s) 602 into two streams or two signal portions (e.g., a first portion and a second portion), where the first signal portion may be sent to the energy harvester module 612 and the second signal portion may be sent to the information decoder module 614. For instance, the power splitting between the first signal portion (sent to the energy harvester module 612) and the second signal portion (sent to the information decoder module 614) may be represented by a ratio of ρ to (1−ρ) as shown, where 0≤ρ≤1 represents the fraction of power allocated for energy harvesting.

The energy harvester module 612 may be similar to the energy harvester module 330, 412, and/or 512. The energy harvester module 612 may include hardware and/or software components configured to receive RF signals (with a power factor of p) from the receive antennas 602 and convert the received RF signals to energy as discussed above with reference to FIG. 3. The information decoder module 614 may include hardware and/or software components configured to receive RF signals (with a power factor of (1-p)) carrying information data (useful information) from the receive antennas 602 and decode the information data from the received RF signals. Accordingly, a transmitting node (e.g., the BSs 105 and/or 205, the UEs 115 and/or 215, and/or the wireless communication devices 220 and/or 300) in communication with the receiver 610 may transmit an RF signal for energy harvesting and an RF signal carrying data information to the receiver 610 at the same time.

In some aspects, when a wireless communication device (e.g., the UEs 115 and/or 215 and/or the wireless communication devices 220 and/or 300), denoted as node j, utilizes the scheme 600, energy harvested by node j from a transmitting node i (an energy provisioning device) can be computed using a random multipath fading channel model as shown below:

Eⱼ=η×ρ×Pᵢ×|gᵢ₋ⱼ|²×T. (4)

The data rate that can be achieved by the node j can be represented by the following relationship:

$${R}_{i - j} = {log}_{2} ( 1 + \frac{{\vert {g}_{i - j} \vert}^{2} \times ( 1 - ρ ) \times {P}_{i}}{κ \times W} ) , \qquad ( 5 )$$

where Rᵢ₋ⱼ represents the data rate.

As can be observed from equation (5) and equation (3), the data rate provided by the scheme 600 utilizing power-splitting can be higher than the data rate provided by the scheme 500 utilizing time-switching.

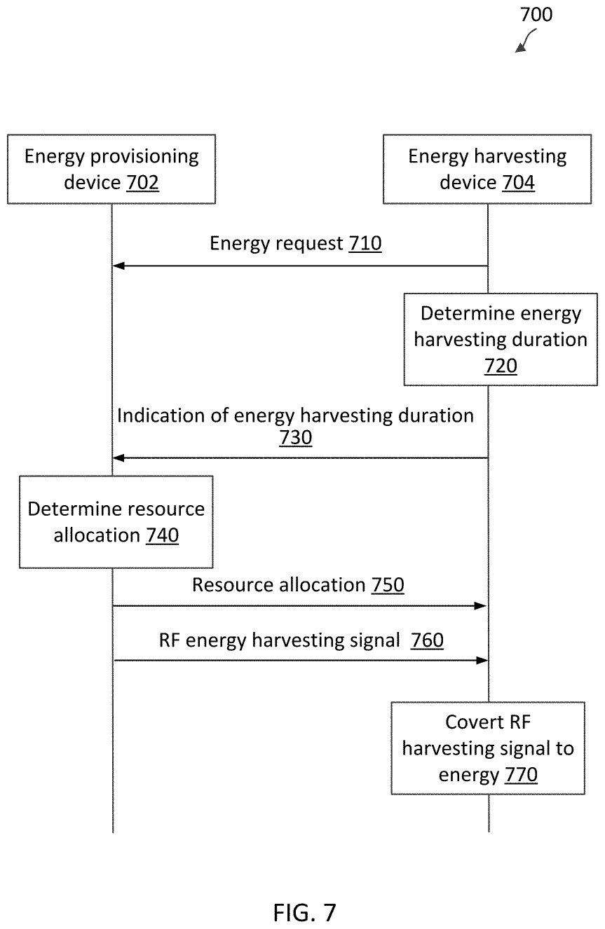

FIGS. 7-10 illustrate various mechanisms for an energy harvesting device (e.g., the UEs 115 and/or 215, the wireless communication devices 220 and/or 300, and/or the receivers 410, 510, and/or 610) to request energy for energy harvesting and for an energy provisioning device (e.g., the BSs 205 and/or 105, the UEs 115 and/or 215, and/or the wireless communication devices 220 and/or 300) to schedule transmissions to provision for energy harvesting.

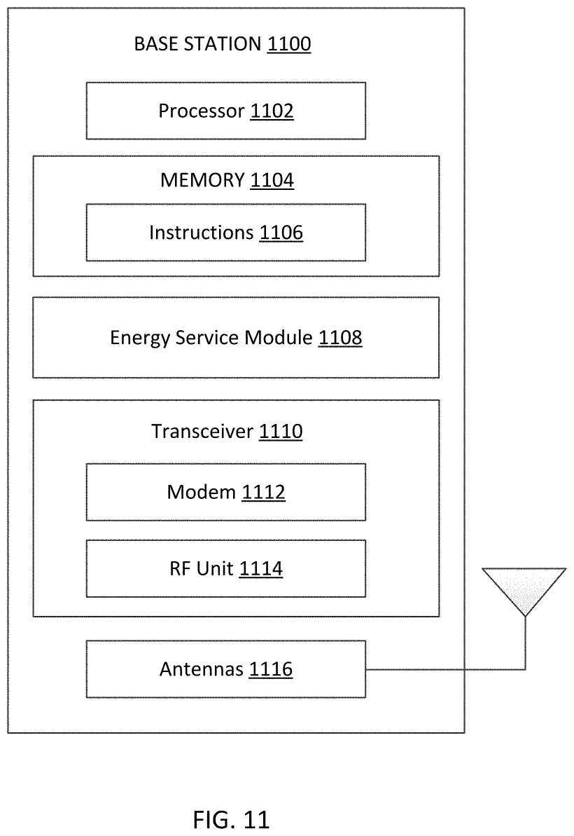

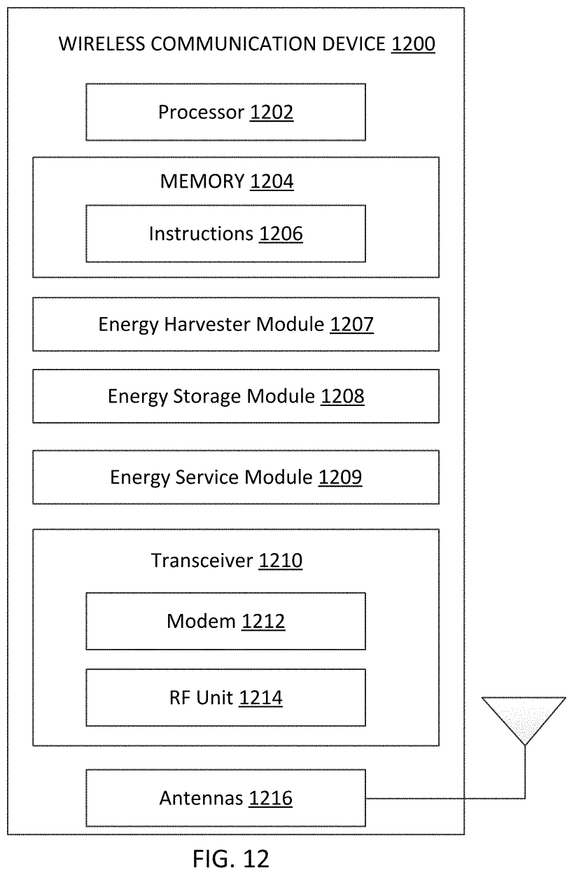

FIG. 7 is a signaling diagram illustrating an RF energy harvesting service provisioning method 700 according to some aspects of the present disclosure. The method 700 may be implemented between an energy provisioning device 702 and an energy harvesting device 704 in a network such as the network 100. In some aspects, the energy provisioning device 702 may be a BS 105, 205, or 1100. For instance, the energy provisioning device 702 may correspond to the BS 1100 of FIG. 11 and may utilize one or more components, such as the processor 1102, the memory 1104, the energy service module 1108, the transceiver 1110, the modem 1112, and the one or more antennas 1116 with reference to FIG. 11, to execute the actions of the method 700. In other aspects, the energy provisioning device 702 may be a UE 115 or a wireless communication device 215, 220, 300, or 1200. For instance, the energy provisioning device 702 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 700. In some aspects, the energy harvesting device 704 may be a UE 115 or a wireless communication device 215, 220, 300, or 1200. For instance, the energy harvesting device 704 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 700. As illustrated, the method 700 includes a number of enumerated actions, but aspects of the method 700 may include additional action(s) before, after, and in between the enumerated action. In some aspects, one or more of the enumerated actions may be omitted or performed in a different order.

In the method 700, the energy harvesting device 704 may establish a connection with the energy provisioning device 702, for example, using mechanisms discussed above with reference to FIG. 1. The energy harvesting device 704 may request for an energy harvesting service from the energy provisioning device 702, and the energy provisioning device 702 may schedule the energy harvesting device 704 for RF signal transmission to enable energy harvesting at the energy harvesting device 704.

At action 710, the energy harvesting device 704 transmits, and the energy provisioning device 702 receives, an energy request. The energy request may indicate a request for an energy harvesting service. The energy harvesting device 704 may autonomously transmit the energy request. That is, the energy harvesting device 704 may initiate the request for the energy harvesting service. For instance, the energy harvesting device 704 may determine that it is low on power (e.g., a battery at the energy harvesting device 704 has a low battery level or a battery level that is below a certain threshold), and thus may initiate the transmission of the energy request. In some aspects, the energy harvesting device 704 may transmit the energy request in a PUSCH. In other aspects, energy harvesting device 704 may transmit the energy request in a PUCCH. The energy harvesting device 704 may transmit the energy request in, for example, one or symbols, one or more sub-slots (groups of symbols), or one or more slots allocated for transmitting an energy request message, a user-assistance information signaling occasion, and/or a configured grant resource.

In some aspects, the energy harvesting device 704 may receive a configuration for a user-assistance information signaling occasion from the energy provisioning device 702. The user-assistance information signaling occasion may be a resource (e.g., including one or more symbols in time and one or more subcarriers in frequency) in which the energy harvesting device 704 may transmit an energy request (e.g., user-assistance information) to the network. The energy harvesting device 704 may transmit user-assistance information including an indication for an energy harvesting service to the energy provisioning device 702. In some aspects, the configuration for the user-assistance information signaling occasion may be an RRC configuration message or an RRC reconfiguration message. In some aspects, the configuration may indicate a periodicity for the user-assistance information signaling occasion. Accordingly, the energy harvesting device 704 may select one of the user-assistance information signaling occasion for transmitting the energy request.

In some aspects, the energy harvesting device 704 may receive a configuration for a configured grant from the energy provisioning device 702. The configured grant may indicate a configured grant resource (e.g., including one or more symbols in time and one or more subcarriers in frequency) in which the energy harvesting device 704 may transmit an energy request. The energy harvesting device 704 may transmit the energy request in the configured grant resource. In some aspects, the configuration for the configured grant an RRC configuration. The configured grant can be a type 1 configured grant or a type 2 configure grant. For type 1 configured grant, the RRC configuration may provide a configured grant resource periodicity and the energy harvesting device 704 may utilize the configured grant resource after the RRC configuration is configured. For type 2 configured grant, the RRC configuration may also provide a configured grant resource periodicity, but the energy harvesting device 704 may not utilize the configured grant resource until an activation (e.g., an activation physical downlink control channel (PDCCH) downlink control information (DCI)) is received from the energy provisioning device 702. When the configured grant includes a periodicity for the configured grant resource, the energy harvesting device 704 may select one of the configured grant resources for transmitting the energy request. In some other aspects, the energy provisioning device 702 may configure aperiodic configured grant resource for the energy harvesting device 704 to transmit the energy request.

In some aspects, the energy harvesting device 704 may optionally indicate an amount of energy that the energy harvesting device 704 desires for the energy harvesting. The energy harvesting device 704 may indicate the amount of energy to be requested for harvesting in the form of a time duration (for accumulating energy). For instance, at action 720, the energy harvesting device 704 determines an energy harvesting duration (e.g., a duration required for harvesting a certain amount of energy to power certain tasks or operations at the energy harvesting device 704). The energy harvesting device 704 may determine the energy harvesting time duration based on at least one of an energy harvesting rate, a number of tasks, a reference transmit power (e.g., Pᵢ used by a transmitting node to transmit an RF energy harvesting signal such as the RF energy harvesting signals 230 and/or 232), a channel parameter (e.g., |gᵢ₋ⱼ|²), or a RF-to-DC conversion parameter (e.g., η). For simplicity, an energy amount to be harvested can be computed for a single channel path and in a single resource element (RE) (e.g., one frequency subcarrier in one symbol), but the energy amount can be computed for multiple paths and/or in multiple REs in a similar way.

As an example, energy harvesting can be performed over a duration T, and the harvested energy can be computed as shown below:

Eⱼ=η×Pᵢ×|gᵢ₋ⱼ|²×T, (6)

where Eⱼ represents the amount of harvested energy at the energy harvesting device 704 (es. node Ali represents a RF-to-DC conversion efficiency of an energy harvester (e.g., the RF energy harvester modules 330 and/or 410) at node j, Pᵢ represents the transmit power at the energy provisioning device 702 (e.g., transmitting node i), |gᵢ₋ⱼ|² represents the channel coefficient of the link (e.g., the links 202 and/or 204) between node i and node j, and T represents the time duration allocated for energy harvesting. In some instances, |gᵢ₋ⱼ|² may be replaced with E{|gᵢ₋ⱼ|}=σₕ². Use of the variance in this context may reduce how often the energy harvesting duration (e.g., number of symbols or time) is reported from the energy harvesting device 704 to the energy provisioning device 702. In this regard, the energy harvesting device 704 may be scheduled to periodically report the energy harvesting duration. However, the energy harvesting device 704 may dynamically report (e.g., outside of the scheduled periodic reporting periods) a change in the energy harvesting duration (e.g., based on the change meeting and/or exceeding a threshold) as determined and/or detected based on the variance (e.g., based on E{|gᵢ₋ⱼ|}=σₕ²).

As another example, energy harvesting can be performed over a duration T, and the harvested energy can be computed as shown below:

E=η(|h|²Pₜₓ)×|h|²×Pₜₓ×T, (7)

where E represents the amount of harvested energy at the energy harvesting device 704, η represents a RF-to-DC conversion efficiency of an energy harvester (e.g., the RF energy harvester modules 330 and/or 410) which in practical energy harvesting circuits may depend on the input power |h|² Pₜₓ, Pₜₓ represents the transmit power at the energy provisioning device 702, h represents the fading channel, and T represents the time duration for the energy harvesting.

The concepts of the present disclosure can be applied to single-input single-output (SISO) scenarios, multiple-input single-output (MISO) scenarios, and/or multiple-input multiple-output (MIMO) scenarios. For MISO scenarios, the channel signal may be beamformed with pᵢ indicating a beam weight used at antenna i of the energy provisioning device 702. Accordingly, the harvested energy can be computed as shown below:

E=η(Pᵢₙ)PᵢₙT=η(|h|²Pₜₓ)×Pₜₓ×|Σ_{i∈{1, . . . ,M}}hᵢpᵢ|²×T, (8)

where E represents the amount of harvested energy at the energy harvesting device 704 (e.g. node j), Pᵢₙ represents the input power to the energy harvesting circuit η(⋅) represents a RF-to-DC conversion efficiency of an energy harvester (e.g., the RF energy harvester modules 330 and/or 410) which may depend on the input power (Pᵢₙ) to the energy harvesting circuit (e.g., η(Pᵢₙ)) Pₜₓ represents the transmit power at the energy provisioning device 702, h represents the fading channel, T represents the time duration for the energy harvesting, M represents the number of antennas, and pᵢ represents the beam weight used at antenna i. Thus, hᵢpᵢx can represent the signal received by the energy harvesting device 704 from antenna i of the energy provisioning device 702. Further, beamforming using singular value decomposition, the beam weight (pᵢ) used at antenna i of the energy provisioning device 702 can be computed as:

$${p}_{i} = \frac{{h}_{i}^{*}}{{\sum }_{i ∈ \{ 1 , … , M \}} {\vert {h}_{i} \vert}^{2}} . \qquad ( 9 )$$

In some instances, the number of transmit antennas may be sufficiently large such that, using the law of large numbers, |Σ_{i∈{1, . . . , M}}hᵢpᵢ|²=Σ_{i∈{1, . . . , M}}|hᵢ|²→Mσₕ², where σₕ²=E{|h|²}. Under such circumstances, the energy harvested by the energy harvesting device 704 may be relatively constant. Accordingly, in some instances the energy harvested by the energy harvesting device 704 may computed as shown below:

E_{harvested}=η(PₜₓMσₕ²)PₜₓMσₕ²T, (10)

For MIMO scenarios, if the energy harvesting device 704 does not apply a receive beamformer/filter to receive the signal, the harvested energy can be computed as shown below:

E_{harvested}=η(Tr{HQPQ*H*})Tr{HQPQ*H*}T (11)

where H_{R×M} represents the MIMO channel matrix, Q represents the precoder matrix, and P represents the power allocation matrix. With equal power allocation, then

$$P = \frac{{P}_{tx}}{min ( M , R )} = q {P}_{tx} ,$$

where M is the number of transmit antennas and R is the number of receive antennas, such that q PₜₓHQ Q*H*. In some instances of MISO and/or MIMI, HH* may be replaced with E{HH*} to determine the best precoding/beamforming matrix at Tx side and also to determine the best filter if the energy harvesting device 704 will use an analog beamformer/filter to receive the signal. In addition, this can be used to determine the required energy by the energy harvesting device 704. Use of the covariance matrix E{HH*} in this context may reduce how often the energy harvesting duration (e.g., number of symbols or time) is reported from the energy harvesting device 704 to the energy provisioning device 702. In this regard, the energy harvesting device 704 may be scheduled to periodically report the energy harvesting duration. However, the energy harvesting device 704 may dynamically report (e.g., outside of the scheduled periodic reporting periods) a change in the energy harvesting duration (e.g., based on the change meeting and/or exceeding a threshold) as determined and/or detected based on the covariance matrix (e.g., based on E{HH*}).

For MIMO scenarios, if the energy harvesting device 704 applies a receive beamformer/filter to receive the signal, the harvested energy can be computed as shown below:

E_{harvested}=η(Tr{Q_{R}HQPQ*H*Q_{R}})Tr{Q_{R}HQPQ*H*Q_{R}}

where Q_{R} is the analog beamformer/filter used at the energy harvesting device 704 to receive the energy signal.
In some cases, the energy provisioning device 702 may dedicate an energy only signal to energy harvesting. In such instances, the energy provisioning device may send the energy harvesting signal using a single layer (e.g., stream) where the single layer is beamformed/precoded by the energy provisioning device 702 using the right-singular vector corresponding to maximum singular value of the channel matrix H (i.e., Q may be a vector and corresponding to right-singular vector of H). In some cases, the energy harvesting device 704 may be capable to apply analog beamforming and can apply the left-singular vector corresponding to the maximum singular value to receive the energy signal. In some instances, the singular value decomposition of a matrix may be H=UΣV*, where the columns of U represent the left-singular vectors matrix, Σ represents the singular values diagonal matrix, and the columns of V represent the right-singular vectors.

In some instances, the number of transmit antennas may be sufficiently large such that

$$\frac{H {H}^{⋆}}{M} = {I}_{r} ,$$

where

$$r = \frac{1}{q} = min ( M , R ) = R .$$

The maximum rank may be equal to R because the number of receive antennas (R) is less than the number of transmit antennas (M) and, in some instances, much less. With equal power allocation among the number of receive antennas (R) and using the best eigenvectors (e.g., corresponding the highest eigenvalues)

$$P = \frac{{P}_{T}}{R} {I}_{r} ,$$

and for large M the energy harvested may be computed as shown below:

E_{harvested}=η(MPₜₓ)MPₜₓT. (12)

The energy harvesting device 704 may determine a number of tasks (e.g., signal processing operations, data encoding, data decoding, data transmission, and/or data reception) to be powered by harvested energy, determine an energy harvesting rate (e.g., an amount of harvested energy per unit time) of an energy harvester (e.g., the energy harvester modules 330, 414, 514, and/or 614) at the energy harvesting device 704, and determine an amount of energy to be requested for harvesting based on the determined number of tasks and the energy harvesting rate. For a given input power Pᵢₙ to the energy harvesting circuit, the energy harvesting device 704 may determine the time duration to be requested for energy harvesting as shown below:

$${T}_{req} = \frac{{E}_{r e q}}{η ( {P}_{in} ) {P}_{in}} , \qquad ( 13 )$$

where E_{req} represents the amount of energy to be requested for harvesting (to power the determined number of tasks) and T_{req} represents the time duration to be requested for accumulating the amount of energy E_{req}.

In some aspects, the energy harvesting device 704 may approximate the time duration T_{req} to a number of symbols (e.g., OFDM symbols) for a given channel bandwidth and a given subcarrier spacing (SCS) as shown below:

$${N}_{req} = ceil ( \frac{{T}_{r e q}}{{T}_{s y m b o l}} ) , \qquad ( 14 )$$

where N_{req} represents the number of symbols to be requested for receiving an RF signal for energy harvesting, cell represents a ceiling operation, and T_{symbol} represents the symbol duration.

In some aspects, the transmit power (Pₜₓ) at the energy provisioning device 702 may be known and/or estimated by the energy harvesting device 704. For example, the energy harvesting device 704 may receive an indication of the transmit power (Pₜₓ) from the energy provisioning device 702. The energy harvesting device 704 may estimate the transmit power (Pₜₓ) based on a reference signal receive power (RSRP), a reference signal received quality (RSRQ), and/or other measurement or measurement estimation. In some instances, the energy harvesting device 704 may determine a charging rate and/or energy harvesting rate for one or more levels of transmit power (Pₜₓ). In some instances, the energy provisioning device 702 may configure one or more reference resources for each level of transmit power (Pₜₓ). The energy harvesting device 704 may receive from the energy provisioning device 702 an indication of the reference resource(s) and/or the associated transmit power(s) (Pₜₓ) (e.g., each resource may be transmitted with a different beam and/or power level). Accordingly, the energy provisioning device 702 may transmit one or more signals using the reference resource(s) using associated beam(s) and/or transmit power(s). The energy harvesting device 704 may receive the signals based on the reference resource(s) and harvest energy from the signals. The energy harvesting device 704 may then measure or otherwise determine the charging rate and/or energy harvesting rate (e.g., in Joules or micro-Joules per symbol, Watts, or other suitable unit of measurement) for each transmit power (Pₜₓ). In this manner, the energy harvesting device 704 may determine the time duration (e.g., T_{req}) to achieve the desired amount of energy harvesting (e.g., E_{req}) for one or more transmit power(s) (Pₜₓ).

In some aspects, the receive power (Pᵣₓ) at the energy harvesting device 704 may be known and/or estimated based on a reference signal receive power (RSRP), a reference signal received quality (RSRQ), input power (Pᵢₙ) to the energy harvesting circuit, energy level, charging rate, and/or other measurement or measurement estimation. The input power (Pᵢₙ) to the energy harvesting circuit may be dependent on and/or based on the receive power (Pᵣₓ) at the energy harvesting device 704. In some instances, the input power (Pᵢₙ) to the energy harvesting circuit may be used as the receive power (Pᵣₓ). In some instances, the energy harvesting device 704 may determine a charging rate and/or energy harvesting rate for one or more levels of receive power (Pᵣₓ). In some instances, the energy harvesting device 704 may transmit an indication of the receive power (Pᵣₓ) to the energy provisioning device 702 for one or more signals associated with reference resource(s). In this regard, the energy harvesting device 704 may receive from the energy provisioning device 702 an indication of the reference resource(s). Each reference resource may be transmitted with a particular beam and/or power level. Accordingly, the energy provisioning device 702 may transmit one or more signals using the reference resource(s) using associated beam(s) and/or transmit power(s). The energy harvesting device 704 may receive the signals based on the reference resource(s) and determine an associated receive power (Pᵣₓ) for each signal. In some instances, the energy harvesting device 704 may measure or otherwise determine a charging rate and/or energy harvesting rate (e.g., in Joules or micro-Joules per symbol, Watts, or other suitable unit of measurement) for each receive power (Pᵣₓ). In this manner, the energy harvesting device 704 may determine the time duration (e.g., T_{req}) to achieve the desired amount of energy harvesting (e.g., E_{req}) for one or more receive power(s) (Pᵣₓ).

In some instances, the energy harvesting device 704 may determine and/or estimate the input power (Pᵢₙ) to the energy harvesting circuit for a received reference signal (e.g., associated with certain beam and power level). The input power (Pᵢₙ) to the energy harvesting circuit may be determined and/or estimated based on an RSRP, an RSRQ, an energy level, and/or a charging rate associated with the received reference signal. In some instances, the energy harvesting device 704 may determine a power difference (P_{Δ}) between the input power (Pᵢₙ) to the energy harvesting circuit and a desired power (P_{Target}) to achieve a target charging rate or energy harvesting rate. In this regard, the target charging rate or energy harvesting rate may be based on the power needed for the energy harvesting device 704 to perform one or more tasks (e.g., receiving, decoding, transmitting, encoding, etc. a certain number of bits, number of transport blocks, and/or other volume of data). In some instances, the energy harvesting device 704 transmits an indication of the power difference (P_{Δ}) to the energy provisioning device 702. In this manner, the energy harvesting device may request the energy provisioning device 702 change the power level based on the power difference (P_{Δ}) to achieve the desired power (P_{Target}) associated with the target charging rate and/or energy harvesting rate. For example, the energy provisioning device 702 may determine an associated change in transmit power (Pₜ) (and/or beam direction) to achieve the desired input power (P_{Target}) to the energy harvesting circuit of the energy harvesting device 704. The energy harvesting device 704 may report the power difference (P_{A}) for one or more transmit power levels and/or receive power levels. In this regard, the energy harvesting device 704 may report the power difference (P_{A}) periodically, ad-hoc (e.g., whenever the energy harvesting device determines the current power level, charging rate, and/or energy harvesting rate is below a threshold), or otherwise.

At action 730, the energy harvesting device 704 transmits, and the energy provisioning device 702 receives, an indication of the energy harvesting duration determined at action 720. In some aspects, the indication of the energy harvesting duration may include an indication of a number of symbols (e.g., OFDM symbols). In some aspects, the energy harvesting duration may be based on a particular transmit power (Pₜₓ) and/or receive power (Pᵣₓ). In some instances, the energy harvesting device 704 transmits, and the energy provisioning device 702 receives, an indication of an energy harvesting duration for each of a plurality of levels of transmit powers (Pₜₓ) and/or receive powers (Pᵣₓ). For example, the energy harvesting device 704 may transmit an indication of a first energy harvesting duration (T_{I}) for a first transmit power (Pₜₓ₁), a second energy harvesting duration (T₂) for a second transmit power (Ptx₂), a third energy harvesting duration (T₃) for a third transmit power (Ptx₃), etc. Similarly, the energy harvesting device 704 may transmit an indication of a first energy harvesting duration (T₁) for a first receive power (Prx₁), a second energy harvesting duration (T₂) for a second receive power (Prx₂), a third energy harvesting duration (T₃) for a third receive power (Prx₃), etc.

At action 740, upon receiving the indication of the energy harvesting duration, the energy provisioning device 702 determines a resource allocation for transmitting an RF energy harvesting signal to the energy harvesting device 704. The energy provisioning device 702 may configure one or more energy harvesting resources (e.g., time-frequency resources including one or more symbols in time and one or more subcarriers in frequency) such that a total number of symbols in the energy harvesting resources is equal to or greater than the number of symbols requested by the energy harvesting device 704 at action 730. In other words, the energy provisioning device 702 may configure a number of energy harvesting resources such that energy accumulated or harvested by the energy harvesting device 704 across the allocated energy harvesting resources exceeds the amount of requested energy E_{req} (or at least equals to E_{req}).

In some aspects, the energy provisioning device 702 may allocate resources for energy harvesting in units of a certain energy harvesting resource size (e.g., about 1 symbol, 2 symbols, 3 symbols or more). If the unit energy harvesting resource size is fixed to a number of symbols, denoted as M_{energy-harvesting}, then the energy provisioning device 702 may configure at least a number of energy harvesting resources for the energy harvesting device 704 as shown below:

$$K = ceil ( \frac{{N}_{r e q}}{{M}_{energy - harvesting}} ) , \qquad ( 15 )$$

where K represents the number of energy harvesting resources to be scheduled for transmitting an RF energy harvesting signal to the energy harvesting device 704 for energy harvesting.

As an example, the energy harvesting device 704 requests for 7 symbols at action 730 and the energy provisioning device 702 utilizes a fixed unit energy harvesting resource size M_{energy-harvesting} of 2 symbols, then the energy provisioning device 702 may allocate four energy harvesting resources (e.g.,

$$K = ceil ( \frac{7}{2} ) = 4 )$$

for the energy harvesting device 704. The energy harvesting device 704 may schedule the four energy harvesting resources in any time and/or frequency arrangements. For instance, the energy harvesting device 704 may allocate a single energy harvesting resource (having a duration of 2 symbols) with a repetition factor of 4 (i.e., 4 instances of the single energy harvesting resource). Alternatively, the energy harvesting device 704 may allocate two energy harvesting resources (each having a duration of 2 symbols) with a repetition factor of 2 (2 instances of the two energy harvesting resources). That is, the energy provisioning device 702 may indicate an energy harvesting resource and a number of repetitions for the energy harvesting resource. In other instances, the energy provisioning device 702 may configure four different energy harvesting resources each with a duration of 2 symbols and may indicate each energy harvesting resource by indicating a starting symbol within a slot and a length or size (number of symbols) of each energy harvesting resource. In yet some other instances, the energy provisioning device 702 may configure four different energy harvesting resources, where three of the energy harvesting resources may each have a duration of 2 symbols and one of the energy harvesting resources may have a duration of 1 symbol.

As discussed above, the indication of the energy harvesting duration by the energy harvesting device 704 is optional. If the energy harvesting device 704 does not indicate the energy harvesting duration to the energy provisioning device 702, the energy provisioning device 702 may allocate a predetermined number of resources for energy harvesting by the energy harvesting device 704.

At action 750, the energy provisioning device 702 transmits, and the energy harvesting device 704 receives, an indication of the one or more resources allocated for energy harvesting. In some aspects, the energy provisioning device 702 transmits, and the energy harvesting device 704 receives, an RRC configuration including an indication of the one or more resources. In other aspects, the energy provisioning device 702 transmits, the energy harvesting device 704 receives, a MAC-CE including an indication of the one or more resources. In other aspects, the energy provisioning device 702 transmits, the energy harvesting device 704 receives, a PDCCH DCI including an indication of the one or more resources.

At action 760, the energy provisioning device 702 transmits, and the energy harvesting device 704 receives, an RF energy harvesting signal (e.g., the RF energy harvesting signals 230 and/or 232) in the one or more resources indicated at action 750. In some aspects, the RF energy harvesting signal may be a signal specific for energy harvesting and may not carry any information data (e.g., data packets), for example, when the energy harvesting device 704 implements the scheme 400 and/or 500 discussed above with reference to FIGS. 4 and 5, respectively. In other aspects, the RF energy harvesting signal can be used for energy harvesting and may carry information data, for example, when the energy harvesting device 704 implements the scheme 600 discussed above with reference to FIG. 6. In some aspects, the energy provisioning device 702 may have information of whether the energy harvesting device 704 utilizes separate RF receive antennas for energy harvesting and information decoding as discussed above with reference to FIG. 4, a single RF receive antennas with time-switching for energy harvesting and information decoding as discussed above with reference to FIG. 5, or a single RF receive antennas with power-splitting for energy harvesting and information decoding as discussed above with reference to FIG. 6. In some aspects, the energy harvesting device 704 may indicate to the energy provisioning device 702 an energy harvesting capability of the energy harvesting device 704. The capability may indicate whether the energy harvesting device 704 can harvest energy and/or whether the energy harvesting device 704 utilizes the scheme 400, 500, or 600 for energy harvesting and information decoding.

At action 770, the energy harvesting device 704 converts the received RF energy harvesting signal to energy, for example, using an energy harvester similar to the energy harvester modules 330, 412, 512, and/or 612. In some instances, the energy harvesting device 704 may store the energy converted or harvested from the received RF energy harvesting signal in an energy storage (e.g., a battery) similar to the energy storage module 310 for later use. In other instances, the energy harvesting device 704 may utilize the harvested energy for current processing or operations at the energy harvesting device 704. That is, the energy harvesting device 704 may harvest energy and immediately utilize the harvested energy. In yet other instances, the energy harvesting device 704 may store a portion of the harvested energy in the energy storage for later use and utilize a portion of the harvested energy to power current processing and/or operations.

In some aspects, upon receiving the energy request from the energy harvesting device 704 at action 710, the energy provisioning device 702 may reduce the amount of data transmission to the energy harvesting device 704, for example, to reduce power consumption at the energy harvesting device 704. In some aspects, the energy harvesting device 704 may transmit the energy request and the indication of the energy harvesting duration in a single transmission. For instance, the energy harvesting device 704 may transmit an energy request message including an indication of a request for an energy harvesting service and a time duration requested for energy harvesting.

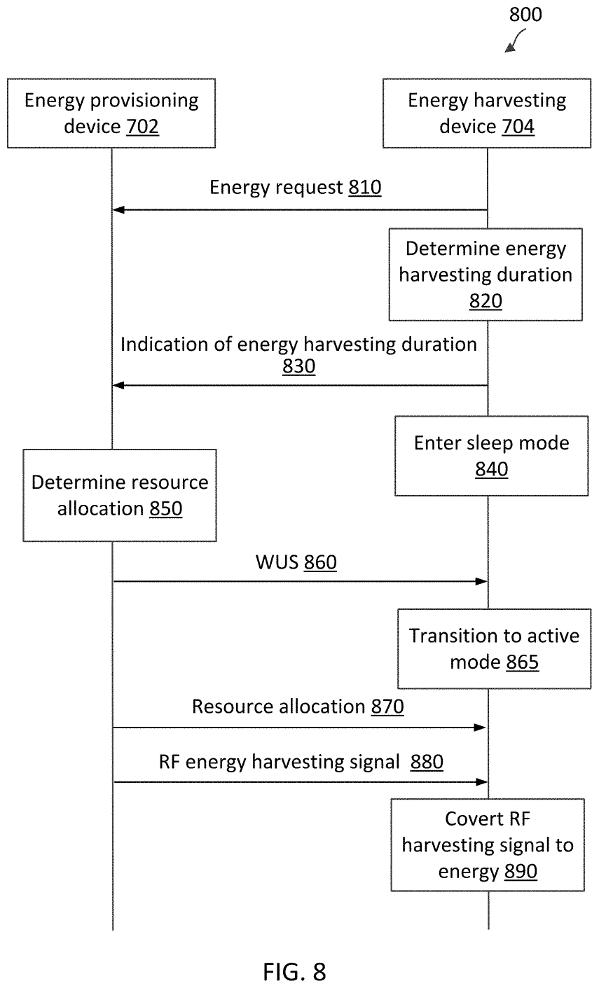

FIG. 8 is a signaling diagram illustrating an RF energy harvesting service provisioning method 800 according to some aspects of the present disclosure. The method 800 may be implemented between an energy provisioning device 702 and an energy harvesting device 704 in a network such as the network 100. In some aspects, the energy provisioning device 702 may be a BS 105, 205, or 1100. For instance, the energy provisioning device 702 may correspond to the BS 1100 of FIG. 11 and may utilize one or more components, such as the processor 1102, the memory 1104, the energy service module 1108, the transceiver 1110, the modem 1112, and the one or more antennas 1116 with reference to FIG. 11, to execute the actions of the method 800. In other aspects, the energy provisioning device 702 may be a UE 115 or a wireless communication device 215, 220, 300, or 1200. For instance, the energy provisioning device 702 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 800. In some aspects, the energy harvesting device 704 may be a UE 115 or a wireless communication device 215, 220, 300, or 1200. For instance, the energy harvesting device 704 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 800. As illustrated, the method 800 includes a number of enumerated actions, but aspects of the method 800 may include additional action(s) before, after, and in between the enumerated action. In some aspects, one or more of the enumerated actions may be omitted or performed in a different order.

Generally speaking, the method 800 includes features similar to method 700 in many respects. For example, actions 810, 820, 830, 850, 870, 880, 890 are similar to actions 710, 720, 730, 740, 750, 760, and 770, respectively. Accordingly, for sake of brevity, details of those actions will not be discussed in detail here

In the method 800, the energy harvesting device 704 may enter a sleep mode after transmitting a request for energy from the energy provisioning device 702. For instance, the energy harvesting device 704 may have a little amount of remaining power available (e.g., the battery is at a low level), and the energy provisioning device 702 may not expect the energy harvesting device 704 to continue to utilize data and/or signal processing components (e.g., digital signal circuitry) during this time (when the energy harvesting device 704 is low on power) for data monitoring and/or decoding.

At action 810, the energy harvesting device 704 transmits, and the energy provisioning device 702 receives, an energy request, for example, using mechanisms as discussed above at action 710.

At action 820, the energy harvesting device 704 determines an energy harvesting duration (e.g., a duration required for harvesting a certain amount of energy to power certain tasks or operations at the energy harvesting device 704), for example, using mechanisms as discussed above at action 720.

At action 830, the energy harvesting device 704 transmits, and the energy provisioning device 702 receives, an indication of the energy harvesting duration determined at action 820, for example, using mechanisms as discussed above at action 730.

At action 840, after the energy harvesting device 704 transmitted the energy request (at action 810) and/or the indication of energy harvesting duration (at action 830), the energy harvesting device 704 enters a sleep mode. In this regard, the energy harvesting device 704 may configure at least some components at the base band and/or RF frontend (e.g., the modem 1212 and/or the RF unit 1214) to operate in a low-power state or sleep state. In other words, the energy harvesting device 704 may operate in a discontinuous reception (DRX) mode. When the energy harvesting device 704 is operating in a sleep mode, the energy harvesting device 704 may not monitor for transmission schedules or receive data from the energy provisioning device 702.

At action 850, in response to the energy request and/or the indication of energy harvesting duration received from the energy harvesting device 704, the energy provisioning device 702 may determine a resource allocation for transmitting an RF energy harvesting signal to the energy harvesting device 704, for example, using mechanisms as discussed above at action 740.

In some aspects, the energy provisioning device 702 may be aware that the energy harvesting device 704 may enter a sleep mode after transmitting the energy request and/or the indication of energy harvesting duration. For instance, the energy harvesting device 704 may include an indication that it will enter a sleep mode along with the transmission of the energy request and/or the indication of energy harvesting duration. In other instances, the energy harvesting device 704 may indicate that energy harvesting device 704 will enter a sleep mode after requesting for energy as part of capability report to the energy provisioning device 702. Accordingly, at action 860, the energy provisioning device 702 transmits, and the energy harvesting device 704 receives, a WUS. In some instances, the WUS may be a predetermined waveform signal. The WUS may function as an indication that an RF energy harvesting signal transmission schedule is to be transmitted to the energy harvesting device 704. The energy provisioning device 702 may transmit the WUS to wake the energy harvesting device 704 from the sleep mode so that the energy harvesting device 704 may monitor for and receive a schedule for receiving an RF energy harvesting signal.

At action 865, upon detecting the WUS, the energy harvesting device 704 may wake up and transition to an active mode. Once in the active mode, the energy harvesting device 704 may monitor for schedules from the energy provisioning device 702.

At action 870, after transmitting the WUS, the energy provisioning device 702 transmits, and the energy harvesting device 704 receives, an indication of the one or more resources allocated for energy harvesting, for example, using mechanisms as discussed above at action 750.

At action 880, the energy provisioning device 702 transmits, and the energy harvesting device 704 receives, an RF energy harvesting signal (e.g., the RF energy harvesting signals 230 and/or 232) in the one or more resources indicated at action 870, for example, using mechanisms as discussed above at action 760.

At action 890, the energy harvesting device 704 converts the received RF energy harvesting signal to energy, for example, using mechanisms as discussed above at action 770.

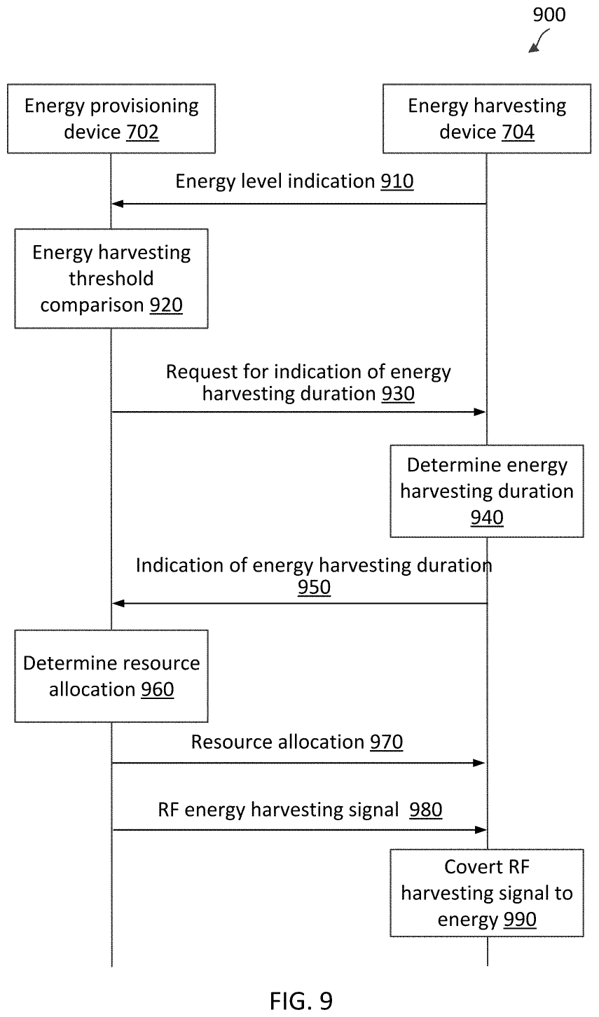

FIG. 9 is a signaling diagram illustrating an RF energy harvesting service provisioning method 900 according to some aspects of the present disclosure. The method 900 may be implemented between an energy provisioning device 702 and an energy harvesting device 704 in a network such as the network 100. In some aspects, the energy provisioning device 702 may be a BS 105, 205, or 1100. For instance, the energy provisioning device 702 may correspond to the BS 1100 of FIG. 11 and may utilize one or more components, such as the processor 1102, the memory 1104, the energy service module 1108, the transceiver 1110, the modem 1112, and the one or more antennas 1116 with reference to FIG. 11, to execute the actions of the method 900. In other aspects, the energy provisioning device 702 may be a UE 115 or a wireless communication device 215, 220, 300, or 1200. For instance, the energy provisioning device 702 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 900. In some aspects, the energy harvesting device 704 may be a UE 115 or a wireless communication device 215, 220, 300, or 1200. For instance, the energy harvesting device 704 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 900. As illustrated, the method 900 includes a number of enumerated actions, but aspects of the method 900 may include additional action(s) before, after, and in between the enumerated action. In some aspects, one or more of the enumerated actions may be omitted or performed in a different order.

Generally speaking, the method 900 includes features similar to method 700 in many respects. For example, actions 940, 950, 960, 970, 980, and 990 are similar to actions 720, 730, 740, 750, 760, and 770, respectively. Accordingly, for sake of brevity, details of those actions will not be discussed in detail here.

In the method 900, instead of the energy harvesting device 704 initiating a request for an energy harvesting service as in the method 700, the energy harvesting device 704 may indicate an energy level (e.g., a battery level) at the energy harvesting device 704 to the energy provisioning device 702, and the energy provisioning device 702 may determine whether to schedule the energy harvesting device 704 with an RF energy harvesting signal based on the indicated level, for example, in comparison to a threshold. In other words, the energy provisioning device 702 may initiate an energy harvesting service.

As shown, at action 910, the energy harvesting device 704 transmits, and the energy provisioning device 702 receives, an energy level indication. For instance, the energy harvesting device 704 may include an energy storage or a battery (e.g., energy storage module 310) that powers operations at the energy harvesting device 704. The energy level indication may indicate an energy level of the energy storage or the battery. In some aspects, the energy level indication may be a quantized energy level. For instance, the energy level indication may indicate whether the energy storage or the battery has a high energy level, a medium energy level, or a low energy level. In some instances, the energy level indication further indicates whether the energy harvesting device 704 has a low energy level that is below a certain threshold or a low energy level that is above the threshold. The energy level indication may serve as an indication to the energy provisioning device 702 whether the energy provisioning device 702 may schedule an RF energy harvesting signal transmission to the energy harvesting device 704 or not.

At action 920, upon receiving the energy level indication from the energy harvesting device 704, the energy provisioning device 702 compares the energy level indicated by the energy level indication to a threshold. If the indicated energy level is below the threshold, the energy provisioning device 702 may to initiate an energy harvesting service for the energy harvesting device 704. If, however, the indicated energy level satisfies the threshold (e.g., exceeds the threshold), the energy provisioning device 702 may not initiate an energy harvesting service for the energy harvesting device 704.

At action 930, the energy provisioning device 702 transmits, and the energy harvesting device 704 receives, a request for an indication of an energy harvesting duration. For instance, if the indicated energy level is below the threshold, the energy provisioning device 702 may request the energy harvesting device 704 to indicate an amount of energy required by the energy harvesting device 704. In some aspects, the energy provisioning device 702 may transmit the request for the indication of the energy harvesting duration via a PDCCH DCI or a MAC-CE.

At action 940, in response to the request for an indication of an energy harvesting duration, the energy harvesting device 704 determines the energy harvesting duration (e.g., a duration required for harvesting a certain amount of energy to power certain tasks or operations at the energy harvesting device 704), for example, using mechanisms as discussed above with reference to action 720.

At action 950, the energy harvesting device 704 transmits, and the energy provisioning device 702 receives, an indication of the energy harvesting duration determined at action 820, for example, using mechanisms as discussed above at action 730.

At action 960, in response to the energy level indication and/or the indication of energy harvesting duration received from the energy harvesting device 704, the energy provisioning device 702 may determines a resource allocation for transmitting an RF energy harvesting signal to the energy harvesting device 704, for example, using mechanisms as discussed above at action 740.

At action 970, the energy harvesting device 704 receives, an indication of the one or more resources allocated for energy harvesting, for example, using mechanisms as discussed above at action 750.

At action 980, the energy provisioning device 702 transmits, the energy harvesting device 704 receives, an RF energy harvesting signal (e.g., the RF energy harvesting signals 230 and/or 232) in the one or more resources indicated at action 970, for example, using mechanisms as discussed above at action 760.

At action 990, the energy harvesting device 704 converts the received RF energy harvesting signal to energy, or example, using mechanisms as discussed above at action 770.

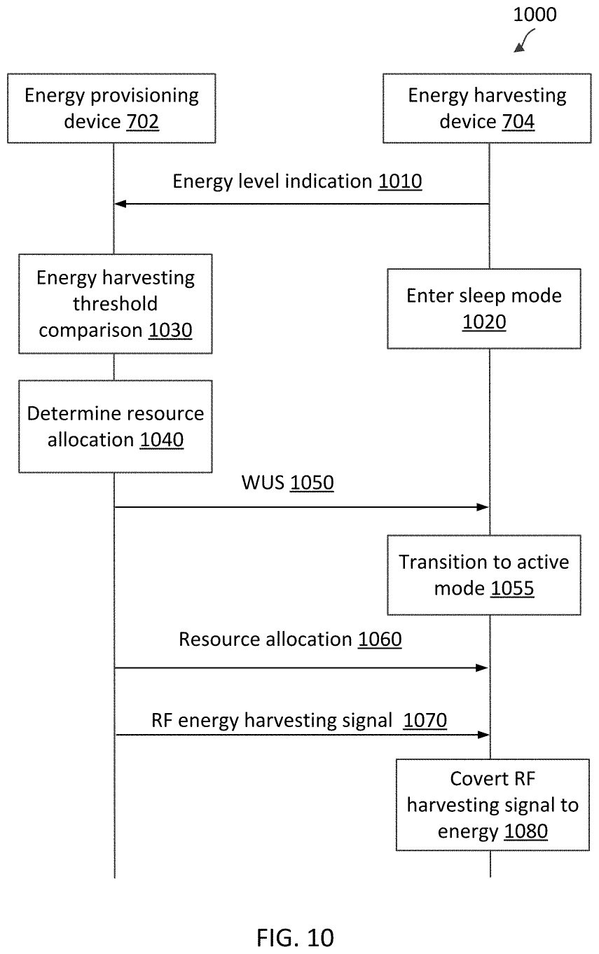

FIG. 10 is a signaling diagram illustrating an RF energy harvesting service provisioning method 1000 according to some aspects of the present disclosure. The method 1000 may be implemented between an energy provisioning device 702 and an energy harvesting device 704 in a network such as the network 100. In some aspects, the energy provisioning device 702 may be a BS 105, 205, or 1100. For instance, the energy provisioning device 702 may correspond to the BS 1100 of FIG. 11 and may utilize one or more components, such as the processor 1102, the memory 1104, the energy service module 1108, the transceiver 1110, the modem 1112, and the one or more antennas 1116 with reference to FIG. 11, to execute the actions of the method 1000. In other aspects, the energy provisioning device 702 may be a UE 115 or a wireless communication device 215, 220, 300, or 1200. For instance, the energy provisioning device 702 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 1000. In some aspects, the energy harvesting device 704 may be a UE 115 or a wireless communication device 215, 220, 300, or 1200. For instance, the energy harvesting device 704 may correspond to the wireless communication device 1200 of FIG. 12 and may utilize one or more components, such as the processor 1202, the memory 1204, the energy harvester module 1207, the energy storage module 1208, the energy service module 1209, the transceiver 1210, the modem 1212, and the one or more antennas 1216 with reference to FIG. 12, to execute the actions of the method 1000. As illustrated, the method 1000 includes a number of enumerated actions, but aspects of the method 1000 may include additional action(s) before, after, and in between the enumerated action. In some aspects, one or more of the enumerated actions may be omitted or performed in a different order.

Generally speaking, the method 1000 includes features similar to method 700 in many respects. For example, actions 1040, 1060, 1070, and 1080 are similar to actions 740, 750, 760, and 770, respectively. Accordingly, for sake of brevity, details of those actions will not be discussed in detail here. Further, the method 1000 includes features similar to method 900. For example, actions 910 and 920 are similar to actions 1010 and 1020, respectively, where the energy harvesting device 704 may indicate an energy level (e.g., a battery level) at the energy harvesting device 704 to the energy provisioning device 702, and the energy provisioning device 702 may determine whether to schedule the energy harvesting device 704 with an RF energy harvesting signal based on the indicated level. Accordingly, for sake of brevity, details of those actions will not be discussed in detail here.

In the method 1000, the energy harvesting device 704 may further enter a sleep mode after indicating the energy level to the energy provisioning device 702. For instance, the energy harvesting device 704 may have a little amount of remaining power (e.g., the battery is at a low level), and the energy provisioning device 702 may not expect the energy harvesting device 704 to continue use the digital signal circuitry during this time (when the energy harvesting device 704 is low on power) for data monitoring and/or decoding.

At action 1010, the energy harvesting device 704 transmits, and the energy provisioning device 702 receives, an energy level indication, for example, using mechanisms as discussed above at action 910.

At action 1020, after the energy harvesting device 704 transmitted the energy level indication (at action 1010), the energy harvesting device 704 enters a sleep mode. In this regard, the energy harvesting device 704 may configure at least some components at the base band and/or RF frontend (e.g., the modem 1212 and/or the RF unit 1214) to operate in a low-power state or sleep state.

At action, 1030, upon receiving the energy level indication from the energy harvesting device 704, the energy provisioning device 702 compares the energy level indicated by the energy level indication to a threshold. If the indicated energy level is below the threshold, the energy provisioning device 702 may to initiate an energy harvesting service for the energy harvesting device 704. If, however, the indicated energy level satisfies the threshold (e.g., exceeds the threshold), the energy provisioning device 702 may not initiate an energy harvesting service for the energy harvesting device 704.

At action 1040, in response to determining that the energy level at the energy harvesting device 704 is below the threshold, the energy provisioning device 702 determines a resource allocation for transmitting an RF energy harvesting signal to the energy harvesting device 704. If the energy harvesting device 704 includes an indication of a time duration requested energy harvesting, the energy provisioning device 702 may determine a resource allocation size using similar mechanisms as discussed above at action 740. In other instances, the energy level indication may not include a requested energy harvesting duration. In such instances, the energy provisioning device 702 may determine a number of resources for the energy harvesting device 704 to harvest energy based on the indicated energy level or some predetermined number of energy harvesting resources.

At action 1050, the energy provisioning device 702 transmits, and the energy harvesting device 704 receives, a WUS. In some instances, the WUS may be a predetermined waveform signal.

At action 1055, upon detecting the WUS, the energy harvesting device 704 may wake up and transition to an active mode. Once in the active mode, the energy harvesting device 704 may monitor for schedules from the energy provisioning device 702.

At action 1060, after transmitting the WUS, the energy provisioning device 702 transmits, and the energy harvesting device 704 receives, an indication of the one or more resources allocated for energy harvesting, for example, using mechanisms as discussed above at action 750.

At action 1070, the energy provisioning device 702 transmits, and the energy harvesting device 704 receives, an RF energy harvesting signal (e.g., the RF energy harvesting signals 230 and/or 232) in the one or more resources indicated at action 1060, for example, using mechanisms as discussed above at action 760.

At action 1080, the energy harvesting device 704 converts the received RF energy harvesting signal to energy, for example, using mechanisms as discussed above at action 770.

In some aspects, the energy harvesting device 704 may utilize any suitable combination of the methods 700, 800, 900, and/or 1000 to receive an energy harvesting service from the energy provisioning device 702. For instance, the energy harvesting device 704 may transmit at least one of an energy request or an energy level indication to the energy provisioning device 702, and the energy provisioning device 702 may respond by scheduling the energy harvesting device 704 for an RF energy harvesting signal transmission.

FIG. 11 is a block diagram of an exemplary BS 1100 according to some aspects of the present disclosure. The BS 1100 may be a BS 105, a BS 205, or an energy provisioning device 702 as discussed in FIGS. 1-10 and 14. As shown, the BS 1100 may include a processor 1102, a memory 1104, an energy service module 1108, a transceiver 1110 including a modem subsystem 1112 and a RF unit 1114, and one or more antennas 1116. These elements may be coupled with one another. The term “coupled” may refer to directly or indirectly coupled or connected to one or more intervening elements. For instance, these elements may be in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 1-10 and 14. Instructions 1106 may also be referred to as program code. The program code may be for causing a wireless communication device to perform these operations, for example by causing one or more processors (such as processor 1102) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The energy service module 1108 may be implemented via hardware, software, or combinations thereof. For example, the energy service module 1108 may be implemented as a processor, circuit, and/or instructions 1106 stored in the memory 1104 and executed by the processor 1102. In some examples, the energy service module 1108 can be integrated within the modem subsystem 1112. For example, the energy service module 1108 can be implemented by a combination of software components (e.g., executed by a DSP or a general processor) and hardware components (e.g., logic gates and circuitry) within the modem subsystem 1112. The energy service module 1108 may communicate with one or more components of BS 1100 to implement various aspects of the present disclosure, for example, aspects of FIGS. 1-10 and 14.

In some aspects, the energy service module 1108 is configured to receive at least one of an energy request or an energy level indication from a wireless communication device. The wireless communication device may be a UE 115, a wireless communication device 215, 220, 300, or an energy harvesting device 704). The energy service module 1108 is further configured to transmit, to the wireless communication device, an indication of one or more resources for transmitting an RF energy harvesting signal. The one or more resources may include one or more symbols in time and one or more subcarriers in frequency. The energy service module 1108 is further configured to transmit the RF energy harvesting signal to the wireless communication device in the one or more resources.

In some aspects, the energy service module 1108 is further configured to receive an indication of an energy harvesting duration from the wireless communication device and determine the one or more resources based on the indicated energy harvesting duration, for example, using equation (14) as discussed above with reference to FIG. 7. In some aspects, the energy service module 1108 is further configured to transmit a request for the indication of the energy harvesting duration in response to receiving the energy level indication, for example, as discussed above in FIGS. 9 and 10.

In some aspects, the energy service module 1108 is further configured to detect that the wireless communication device is operating in a sleep mode, transmit a WUS to the wireless communication device before transmitting the indication of the one or more resources to the wireless communication device, for example, as discussed above with reference to FIGS. 8 and 10.

As shown, the transceiver 1110 may include the modem subsystem 1112 and the RF unit 1114. The transceiver 1110 can be configured to communicate bi-directionally with other devices, such as the UEs 115 and/or BS 1100 and/or another core network element. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data (e.g., RRC configurations, MIB, SIB, PDSCH data and/or PDCCH DCIs, RF energy harvesting signal, request for indication of energy harvesting duration, WUS, energy harvesting resource allocation, etc.) from the modem subsystem 1112 (on outbound transmissions) or of transmissions originating from another source such as a UE 115, a wireless communication device 215, 220, 300, or 1200. The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the BS 1100 to enable the BS 1100 to communicate with other devices.

The RF unit 1114 may provide the modulated and/or processed data, e.g. data packets (or, more generally, data messages that may contain one or more data packets and other information), to the antennas 1116 for transmission to one or more other devices. The antennas 1116 may further receive data messages transmitted from other devices and provide the received data messages for processing and/or demodulation at the transceiver 1110. The transceiver 1110 may provide the demodulated and decoded data (e.g., PUSCH data, PUCCH UCI, MSG1, MSG3, energy request, energy level indication, indication of energy harvesting duration, user-assistance information, etc.) to the energy service module 1108 for processing. The antennas 1116 may include multiple antennas of similar or different designs in order to sustain multiple transmission links.

In an aspect, the BS 1100 can include multiple transceivers 1110 implementing different RATs (e.g., NR and LTE). In an aspect, the BS 1100 can include a single transceiver 1110 implementing multiple RATs (e.g., NR and LTE). In an aspect, the transceiver 1110 can include various components, where different combinations of components can implement different RATs.

Further, in some aspects, the processor 1102 is coupled to the memory 1104 and the transceiver 1110. The processor 1102 is configured to receive, from a wireless communication device via the transceiver 1110, at least one of an energy request or an energy level indication. The processor 1102 is further configured to transmit, to the second wireless communication device via the transceiver 1110 in response to the at least one of the energy request or the energy level indication, an indication of one or more resources for transmitting a radio frequency (RF) energy harvesting signal. The processor 1102 is further configured to transmit, to the second wireless communication device in the one or more resources via the transceiver 1110, the RF energy harvesting signal.

FIG. 12 is a block diagram of an exemplary wireless communication device 1200 according to some aspects of the present disclosure. The wireless communication device 1200 may be a UE 115, a wireless communication device 215, 220, 300, an energy provisioning device 702, or an energy harvesting device 704 as discussed above in FIGS. 1-10 and 13-14. As shown, the wireless communication device 1200 may include a processor 1202, a memory 1204, an energy harvester module 1207, an energy storage module 1208, an energy service module 1209, a transceiver 1210 including a modem subsystem 1212 and a radio frequency (RF) unit 1214, and one or more antennas 1216. These elements may be coupled with one another. The term “coupled” may refer to directly or indirectly coupled or connected to one or more intervening elements. For instance, these elements may be in direct or indirect communication with each other, for example via one or more buses.

The processor 1202 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1202 may also be implemented as a combination of computing devices, e.g., a combination of a DSP and a microprocessor, a plurality of microprocessors, one or more microprocessors in conjunction with a DSP core, or any other such configuration.

The memory 1204 may include a cache memory (e.g., a cache memory of the processor 1202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1204 includes a non-transitory computer-readable medium. The memory 1204 may store, or have recorded thereon, instructions 1206. The instructions 1206 may include instructions that, when executed by the processor 1202, cause the processor 1202 to perform the operations described herein with reference to a UE 115 or an anchor in connection with aspects of the present disclosure, for example, aspects of FIGS. 1-10 and 13-14. Instructions 1206 may also be referred to as code, which may be interpreted broadly to include any type of computer-readable statement(s) as discussed above with respect to FIG. 11.

In some aspects, the energy harvester module 1207 may include hardware and/or software components configured to receive RF signals (e.g., RF energy harvesting signal 230 and/or 232) from the RF antennas 1216 and covert the received RF signals into energy for storage at the energy storage module 1208. The energy harvester module 1207 may be similar to the energy harvester modules 330, 412, 512, and/or 612. In some aspects, the energy harvester module 1207 may include impedance matching circuitry, rectifier circuitry, and/or capacitor(s) as discussed above with reference to FIG. 3. The energy storage module 1208 may include capacitor(s) or a battery that can store harvested energy for later use.

The energy service module 1209 may be implemented via hardware, software, or combinations thereof. For example, the energy service module 1209 may be implemented as a processor, circuit, and/or instructions 1206 stored in the memory 1204 and executed by the processor 1202. In some aspects, the energy service module 1209 can be integrated within the modem subsystem 1212. For example, the energy service module 1209 can be implemented by a combination of software components (e.g., executed by a DSP or a general processor) and hardware components (e.g., logic gates and circuitry) within the modem subsystem 1212. The energy service module 1209 may communicate with one or more components of wireless communication device 1200 to implement various aspects of the present disclosure, for example, aspects of FIGS. 1-10 and 13-14.

In some aspects, the wireless communication device 1200 may include one or more of the energy harvester module 1207, the energy storage module 1208, and the energy service module 1209. In other aspects, the wireless communication device 1200 may include all of the energy harvester module 1207, the energy storage module 1208, and the energy service module 1209.

In some aspects, the wireless communication device 1200 may operate as an energy harvesting device. For instance, the energy service module 1209 is configured to transmit at least one of an energy request or an energy level indication to a wireless communication device. The wireless communication device may be a BS 105 or 205, a UE 115, the wireless communication device 215, 220, or 330, or an energy harvesting device 704. The energy service module 1209 is further configured to receive an indication of one or more resources for receiving a RF energy harvesting signal from the wireless communication device. The one or more resources may include one or more symbols in time and one or more subcarriers in frequency. The energy service module 1209 is further configured to receive an RF energy harvesting signal from the wireless communication device in the one or more resources.

In some aspects, the energy service module 1209 is further configured to determine an energy harvesting duration based on based on at least one of an energy harvesting rate, a number of tasks, a reference transmit power, a channel parameter, or a radio frequency-to-energy conversion parameter transmit an indication of the energy harvesting duration to the wireless communication device, for example, using equations (6)-(12) as discussed above with reference to FIG. 7. The energy service module 1209 is further configured to transmit an indication of the determined energy harvesting duration to the wireless communication device. In some aspects, the energy service module 1209 is further configured to receive a request for the indication of the energy harvesting duration, where the indication of the energy harvesting duration may be transmitted in response to the request. In some aspects, energy service module 1209 is further configured to receive the request for the indication of the energy harvesting duration in response to transmitting the energy level indication.

In some aspects, the energy service module 1209 is further configured to enter a sleep mode after transmitting the at least one of the energy request or the energy level indication, detect a WUS while in the sleep mode, transition from the sleep mode to an active mode, and receive the indication of the one or more resources for receiving the RF energy harvesting signal after waking up, for example, as discussed above with reference to FIGS. 8 and 10.

In other aspects, the wireless communication device 1200 operates as an energy provisioning device. For instance, the energy service module 1209 is configured to receive at least one of an energy request or an energy level indication from a wireless communication device. The wireless communication device may be a UE 115, a wireless communication device 215 or an energy harvesting device 704). The energy service module 1209 is further configured to transmit, to the wireless communication device, an indication of one or more resources for transmitting an RF energy harvesting signal. The one or more resources may include one or more symbols in time and one or more subcarriers in frequency. The energy service module 1209 is further configured to transmit the RF energy harvesting signal to the wireless communication device in the one or more resources.

In some aspects, the energy service module 1209 is further configured to receive an indication of an energy harvesting duration from the wireless communication device and determine the one or more resources based on the indicated energy harvesting duration, for example, using equation (14) as discussed above with reference to FIG. 7. In some aspects, the energy service module 1209 is further configured to transmit a request for the indication of the energy harvesting duration in response to receiving the energy level indication.

In some aspects, the energy service module 1209 is further configured to detect that the wireless communication device is operating in a sleep mode, transmit a WUS to the wireless communication device before transmitting the indication of the one or more resources to the wireless communication device, for example, as discussed above with reference to FIGS. 8 and 10.

As shown, the transceiver 1210 may include the modem subsystem 1212 and the RF unit 1214. The transceiver 1210 can be configured to communicate bi-directionally with other devices, such as the BSs 105 and 1100. The modem subsystem 1212 may be configured to modulate and/or encode the data from the memory 1204 and/or the energy service module 1209 according to a modulation and coding scheme (MCS), e.g., a low-density parity check (LDPC) coding scheme, a turbo coding scheme, a convolutional coding scheme, a digital beamforming scheme, etc. The RF unit 1214 may be configured to process (e.g., perform analog to digital conversion or digital to analog conversion, etc.) modulated/encoded data (e.g., PUSCH data, PUCCH UCI, MSG1, MSG3, energy request, energy level indication, indication of energy harvesting duration, user-assistance information, etc.) or of transmissions originating from another source such as a UE 115, a BS 105, or an anchor. The RF unit 1214 may be further configured to perform analog beamforming in conjunction with the digital beamforming. Although shown as integrated together in transceiver 1210, the modem subsystem 1212 and the RF unit 1214 may be separate devices that are coupled together at the wireless communication device 1200 to enable the wireless communication device 1200 to communicate with other devices.

The RF unit 1214 may provide the modulated and/or processed data, e.g. data packets (or, more generally, data messages that may contain one or more data packets and other information), to the antennas 1216 for transmission to one or more other devices. The antennas 1216 may further receive data messages transmitted from other devices. The antennas 1216 may provide the received data messages for processing and/or demodulation at the transceiver 1210. The transceiver 1210 may provide the demodulated and decoded data (e.g., RRC configurations, MIB, SIB, PDSCH data and/or PDCCH DCIs, RF energy harvesting signal, request for indication of energy harvesting duration, WUS, energy harvesting resource allocation, etc.) to the energy service module 1209 for processing. The antennas 1216 may include multiple antennas of similar or different designs in order to sustain multiple transmission links.

In an aspect, the wireless communication device 1200 can include multiple transceivers 1210 implementing different RATs (e.g., NR and LTE). In an aspect, the wireless communication device 1200 can include a single transceiver 1210 implementing multiple RATs (e.g., NR and LTE). In an aspect, the transceiver 1210 can include various components, where different combinations of components can implement different RATs.

Further, in some aspects, the processor 1202 is coupled to the memory 1204, the energy harvester module 1207, and the transceiver 1210. The processor 1202 is configured to transmit, to a second wireless communication device via the transceiver 1210, at least one of an energy request or an energy level indication. The processor 1202 is further configured to receive, from the second wireless communication device via the transceiver 1210 in response to the at least one of the energy request or the energy level indication, an indication of one or more resources for receiving a radio frequency (RF) energy harvesting signal. The processor 1202 is further configured to receive, from the second wireless communication device in the one or more resources via the transceiver 1210, the RF energy harvesting signal. The processor 1202 is further configured to convert, via the energy harvester module 1207, the RF energy harvesting signal to energy.

Further, in some aspects, the processor 1202 is coupled to the memory 1204 and the transceiver 1210. The processor 1202 is configured to receive, from a wireless communication device via the transceiver 1210, at least one of an energy request or an energy level indication. The processor 1202 is further configured to transmit, to the second wireless communication device via the transceiver 1210 in response to the at least one of the energy request or the energy level indication, an indication of one or more resources for transmitting a radio frequency (RF) energy harvesting signal. The processor 1202 is further configured to transmit, to the second wireless communication device in the one or more resources via the transceiver 1110, the RF energy harvesting signal.

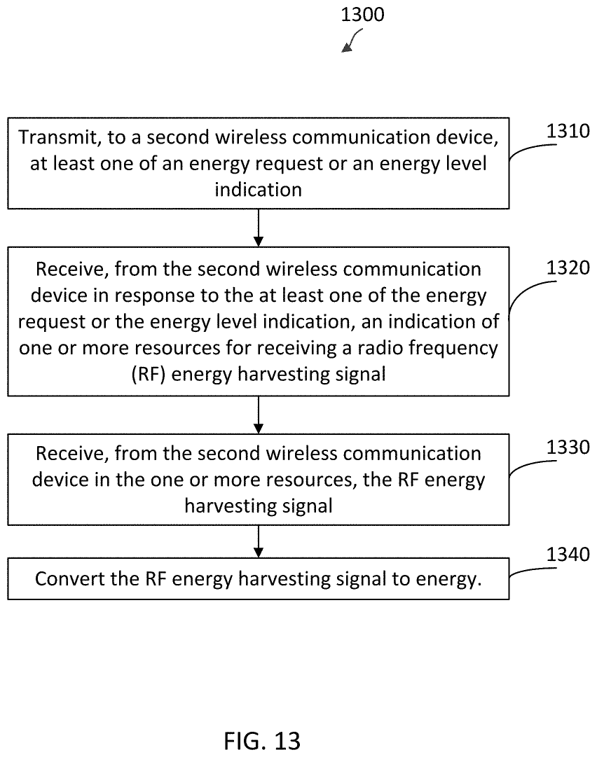

FIG. 13 is a flow diagram illustrating a wireless communication method 1300 according to some aspects of the present disclosure. Aspects of the method 1300 can be executed by a computing device (e.g., a processor, processing circuit, and/or other suitable component) of a wireless communication device or other suitable means for performing the blocks. In one aspect, a wireless communication device, such as a UE 115, an energy harvesting device 704, or a wireless communication device 215, 220, 300, 1200 may utilize one or more components, such as the processor 1202, the memory 1204, the energy harvester module 1207, the energy storage module 1208, the energy service module 1209, the transceiver 1210, the modem 1212, the RF unit 1214, and the one or more antennas 1216, to execute the blocks of method 1300. The method 1300 may employ similar mechanisms as described in FIGS. 1-10. As illustrated, the method 1300 includes a number of enumerated blocks, but aspects of the method 1300 may include additional blocks before, after, and in between the enumerated blocks. In some aspects, one or more of the enumerated blocks may be omitted or performed in a different order.

At block 1310, a first wireless communication device transmits, to a second wireless communication device, at least one of an energy request or an energy level indication. In some aspects, the first wireless communication device may be a UE such as a UE 115, a wireless communication device 215, 220, 300, or an energy harvesting device 704, and the second wireless communication device may be a BS such as the BS 105, 205, another UE 115, or the energy provisioning device 702. In some aspects, means for performing the functionality of block 1310 can, but not necessarily, include, for example, the processor 1202, the memory 1204, the energy harvester module 1207, the energy storage module 1208, the energy service module 1209, the transceiver 1210, the modem 1212, the RF unit 1214, and the one or more antennas 1216 with reference to FIG. 12.

In some aspects, the first wireless communication device may transmit the energy request during a the user-assistance information signaling occasion. The first wireless communication device may receive a configuration (e.g., an RRC configuration or RRC reconfiguration) for the user-assistance information signaling occasion. The configuration may indicate one or more symbols in time and one or more subcarriers in frequency configured for the user-assistance information signaling occasion. In some aspects, the first wireless communication device may transmit the energy request in a configured grant resource. The first wireless communication device may receive a configuration (e.g., an RRC configuration or RRC reconfiguration) indicating a configured grant granting the configured grant resource, which may include one or more symbols in time and one or more subcarriers in frequency.

In some aspects, the first wireless communication device may transmit the energy level indication indicating an energy level or a remaining battery energy level of the first wireless communication device. For instance, the indication may indicate a low energy level satisfying a threshold, a low energy level failing to satisfy the threshold, a medium energy level, or a high energy level.

At block 1320, the first wireless communication device receives, from the second wireless communication device in response to the at least one of the energy request or the energy level indication, an indication of one or more resources for receiving a RF energy harvesting signal. The one or more resources may include one or more symbols in time and one or more subcarriers in frequency. In some aspects, the indication may indicate a resource in a fixed unit resource size and a repetition factor associated with the resource. As an example, the indication may indicate a resource with a fix unit size of 2 symbols (e.g., OFDM symbols) and a repetition factor of 4. As such, 8 symbols may be allocated for receiving the RF energy harvesting signal (for energy harvesting). In another example, the indication may indicate a first resource in a fixed unit resource size and a repetition factor associated with the resource and a second resource with a different unit resource size. In a further example, the indication may indicate a plurality of resources by indicating a starting symbol within a slot and a length or number of symbols for each of the plurality of resources. In some aspects, means for performing the functionality of block 1320 can, but not necessarily, include, for example, the processor 1202, the memory 1204, the energy harvester module 1207, the energy storage module 1208, the energy service module 1209, the transceiver 1210, the modem 1212, the RF unit 1214, and the one or more antennas 1216 with reference to FIG. 12.

At block 1330, the first wireless communication device receives, from the second wireless communication device in the one or more resources, the RF energy harvesting signal. The RF energy harvesting signal may be similar to the RF energy harvesting signal 230 and/or 232. In some aspects, the RF energy harvesting signal may be a signal specific for energy harvesting and may not carry any information data (e.g., when the first wireless communication device have a receiver architecture as discussed above with reference to FIGS. 4 and 5). In other aspects, the RF energy harvesting signal may be carry information data and can be used for energy harvesting (e.g., when the first wireless communication device have a receiver architecture as discussed above with reference to FIG. 6). In some aspects, means for performing the functionality of block 1330 can, but not necessarily, include, for example, the processor 1202, the memory 1204, the energy harvester module 1207, the energy storage module 1208, the energy service module 1209, the transceiver 1210, the modem 1212, the RF unit 1214, and the one or more antennas 1216 with reference to FIG. 12.

At block 1340, the first wireless communication device converts the RF energy harvesting signal to energy, for example, using an energy harvester similar to the energy harvester modules 330, 412, 512, and/or 612. In some instances, the first wireless communication device may store the energy converted or harvested from the received RF energy harvesting signal in an energy storage (e.g., a battery) similar to the energy storage module 310 for later use. In other instances, the first wireless communication device may utilize the harvested energy for current processing or operations at the first wireless communication device. That is, the first wireless communication device may harvest energy and immediately utilize the harvested energy. In yet other instances, the wireless communication device may store a portion of the harvested energy in the energy storage for later use and utilize a portion of the harvested energy to power current processing and/or operations. In some aspects, means for performing the functionality of block 1340 can, but not necessarily, include, for example, the processor 1202, the memory 1204, the energy harvester module 1207, the energy storage module 1208, the energy service module 1209, the transceiver 1210, the modem 1212, the RF unit 1214, and the one or more antennas 1216 with reference to FIG. 12.

In some aspects, the first wireless communication device may further transmit an indication of an energy harvesting time duration. In some aspects, the first wireless communication device may determine the energy harvesting time duration based on at least one of an energy harvesting rate, a number of tasks, a reference transmit power (e.g., a transmit power used by the second wireless communication device for transmitting the RF energy harvesting signal), a channel parameter (e.g., a channel coefficient associated with a link between the first wireless communication device and the second wireless communication device), or a radio frequency-to-energy conversion parameter (e.g., η). For instance, the first wireless communication device may determine a number of tasks (e.g., signal processing operations, data encoding, data decoding, data transmission, and/or data reception) to be powered by harvested energy, determine an energy, harvesting rate (e.g., an amount of harvested energy per unit time) of an energy harvester (e.g., the energy harvester modules 330, 414, 514, and/or 614) at the first wireless communication device, and determine an amount of energy to be requested for harvesting based on the determined number of tasks and the energy harvesting rate. The first wireless communication device may subsequently determine the energy harvesting time duration as discussed above with reference to equation (13). In some aspects, the transmitting the indication of the energy harvesting time duration may include transmitting an indication of a number of symbols (e.g., a number of OFDM symbols). For instance, the first wireless communication device may compute the number of symbols as discussed above with reference to equation (14). In some aspects, a size of the one or more resources indicated at block 1330 may be based on the energy harvesting time duration, for example, as discussed above with reference to equation (15).

In some aspects, the first wireless communication device may receive a request for the indication of the energy harvesting time duration, for example, in response to transmitting the energy indication at block 1310.

In some aspects, the first wireless communication device may entering a sleep mode after transmitting the at least one of the energy request or the energy level indication. For instance, the first wireless communication device may have a low energy level (e.g., battery energy level), and thus may enter the sleep mode to conserve power until energy can be harvested. The wireless communication device may detect a wake-up signal (WUS) while in the sleep mode, and the receiving the indication of the one or more resources at block 1320 may be further in response to detecting the WUS.

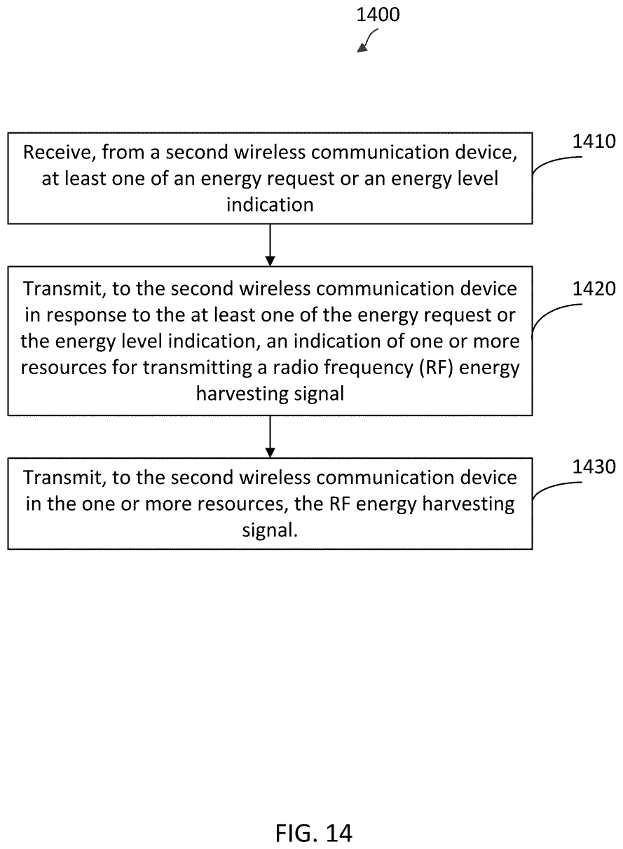

FIG. 14 is a flow diagram illustrating a wireless communication method 1400 according to some aspects of the present disclosure. Aspects of the method 1400 can be executed by a computing device (e.g., a processor, processing circuit, and/or other suitable component) of a wireless communication device or other suitable means for performing the blocks. In one aspect, a BS, such as a B S 105, 205, or 1100 may utilize one or more components, such as the processor 1102, the memory 1104, the energy service module 1108, the transceiver 1110, the modem 1112, the RF unit 1114, and the one or more antennas 1116, to execute the blocks of method 1400. In another aspect, a wireless communication device, such as a UE 115, the energy harvesting device 704, or a wireless communication device 215, 220, 300, 1200 may utilize one or more components, such as the processor 1202, the memory 1204, the energy harvester module 1207, the energy storage module 1208, the energy service module 1209, the transceiver 1210, the modem 1212, the RF unit 1214, and the one or more antennas 1216, to execute the blocks of method 1400. The method 1400 may employ similar mechanisms as described in FIGS. 1-10. As illustrated, the method 1400 includes a number of enumerated blocks, but aspects of the method 1400 may include additional blocks before, after, and in between the enumerated blocks. In some aspects, one or more of the enumerated blocks may be omitted or performed in a different order.

At block 1410, a first wireless communication device receives, from a second wireless communication device, at least one of an energy request or an energy level indication. In some aspects, the first wireless communication device may be a BS such as the BS 105, 205 or the energy provisioning device 702, and the second wireless communication device may be a UE such as a UE 115, a wireless communication device 215, 220, 300, or an energy harvesting device 704. In other aspects, the first wireless communication device may be a UE such as a UE 115, a wireless communication device 215, 220, 300, or an energy provisioning device 702, and the second wireless communication device may be another UE such as a UE 115, a wireless communication device 215, 220, 300, or an energy harvesting device 704. In some aspects, means for performing the functionality of block 1310 can, but not necessarily, include, for example, the processor 1102, the memory 1104, the energy service module 1108, the transceiver 1110, the modem 1112, the RF unit 1114, and the one or more antennas 1116 with reference to FIG. 11, or the processor 1202, the memory 1204, the energy harvester module 1207, the energy storage module 1208, the energy service module 1209, the transceiver 1210, the modem 1212, the RF unit 1214, and the one or more antennas 1216 with reference to FIG. 12.

In some aspects, the first wireless communication device may receive the energy request during a the user-assistance information signaling occasion. The first wireless communication device may transmit a configuration (e.g., an RRC configuration or RRC reconfiguration) for the user-assistance information signaling occasion. The configuration may indicate one or more symbols in time and one or more subcarriers in frequency configured for the user-assistance information signaling occasion. In some aspects, the first wireless communication device may receive the energy request in a configured grant resource. The first wireless communication device may transmit a configuration (e.g., an RRC configuration or RRC reconfiguration) indicating a configured grant granting the configured grant resource, which may include one or more symbols in time and one or more subcarriers in frequency.

In some aspects, the first wireless communication device may receive the energy level indication indicating an energy level or a remaining battery energy level of the second wireless communication device. For instance, the indication may indicate a low energy level satisfying a threshold, a low energy level failing to satisfy the threshold, a medium energy level, or a high energy level.

At block 1420, the first wireless communication device transmits, to the second wireless communication device in response to the at least one of the energy request or the energy level indication, an indication of one or more resources for transmitting an RF energy harvesting signal. The one or more resources may include one or more symbols in time and one or more subcarriers in frequency. In some aspects, the indication may indicate a resource in a fixed unit resource size and a repetition factor associated with the resource. As an example, the indication may indicate a resource with a fix unit size of 2 symbols (e.g., OFDM symbols) and a repetition factor of 4. As such, 8 symbols may be allocated for receiving the RF energy harvesting signal (for energy harvesting). In another example, the indication may indicate a first resource in a fixed unit resource size and a repetition factor associated with the resource and a second resource with a different unit resource size. In a further example, the indication may indicate a plurality of resources by indicating a starting symbol within a slot and a length or number of symbols for each of the plurality of resources. In some aspects, means for performing the functionality of block 1420 can, but not necessarily, include, for example, the processor 1102, the memory 1104, the energy service module 1108, the transceiver 1110, the modem 1112, the RF unit 1114, and the one or more antennas 1116 with reference to FIG. 11, or the processor 1202, the memory 1204, the energy harvester module 1207, the energy storage module 1208, the energy service module 1209, the transceiver 1210, the modem 1212, the RF unit 1214, and the one or more antennas 1216 with reference to FIG. 12.

At block 1430, the first wireless communication device transmits, to the second wireless communication device in the one or more resources, the RF energy harvesting signal. The RF energy harvesting signal may be similar to the RF energy harvesting signal 230 and/or 232. In some aspects, the RF energy harvesting signal may be a signal specific for energy harvesting and may not carry any information data (e.g., when the second wireless communication device indicates a receiver architecture as discussed above with reference to FIGS. 4 and 5). In other aspects, the RF energy harvesting signal may be carry information data and can be used for energy harvesting (e.g., when the first wireless communication device indicates a receiver architecture as discussed above with reference to FIG. 6). In some aspects, means for performing the functionality of block 1430 can, but not necessarily, include, for example, the processor 1102, the memory 1104, the energy service module 1108, the transceiver 1110, the modem 1112, the RF unit 1114, and the one or more antennas 1116 with reference to FIG. 11, or the processor 1202, the memory 1204, the energy harvester module 1207, the energy storage module 1208, the energy service module 1209, the transceiver 1210, the modem 1212, the RF unit 1214, and the one or more antennas 1216 with reference to FIG. 12.

In some aspects, the first wireless communication device may further receive, from the second wireless communication device, an indication of an energy harvesting time duration. The energy harvesting time duration is based on at least one of an energy harvesting rate, a number of tasks, a reference transmit power (e.g., a transmit power used by the first wireless communication device for transmitting the RF energy harvesting signal), a channel parameter (e.g., (e.g., a channel coefficient associated with a link between the first wireless communication device and the second wireless communication device), or a radio frequency-to-energy conversion parameter (e.g., η) as discussed above with reference to equation (13). In some aspects, the receiving the indication of the energy harvesting time duration may include receiving an indication of a number of symbols (e.g., a number of OFDM symbols). In some aspects, a size of the one or more resources indicated at block 1420 may be based on the energy harvesting time duration. In some aspects, the first wireless communication device may determine the size of the one or more resources based on at least one of the energy harvesting time duration or an energy harvesting unit resource, for example, as discussed above with reference to action 740 of FIG. 7.

In some aspects, the first wireless communication device may transmit a request for the indication of the energy harvesting time duration, for example, in response to receiving the energy indication at block 1410.

In some aspects, the first wireless communication device may further detect that the second wireless communication device is operating in a sleep mode. The first wireless communication device may further transmit, to the second wireless communication device, a WUS. In some aspects, the first wireless communication device may transmit the WUS to wake the second wireless communication device from the sleep mode before transmitting the indication of the one or more resources.

In some aspects, the first wireless communication device may further refrain, based on the at least one of the energy request or the energy level indication, from scheduling a communication with the second wireless communication device. For instance, the first wireless communication device may reduce an amount data transmission for the second wireless communication device.

Further aspects of the present disclosure include the following:

1. A method of wireless communication performed by a first wireless communication device, the method comprising:

transmitting, to a second wireless communication device, at least one of an energy request or an energy level indication;

receiving, from the second wireless communication device in response to the at least one of the energy request or the energy level indication, an indication of one or more resources for receiving a radio frequency (RF) energy harvesting signal;

receiving, from the second wireless communication device in the one or more resources, the RF energy harvesting signal; and

converting the RF energy harvesting signal to energy.

2. The method of aspect 1, further comprising:

receiving a configuration for a user-assistance information signaling occasion,

wherein the transmitting the at least one of the energy request or the energy level indication comprises:
transmitting, during the user-assistance information signaling occasion, the energy request.
   3. The method of aspect 1, further comprising:

receiving a configuration for a configured grant resource,

wherein the transmitting the at least one of the energy request or the energy level indication comprises:
transmitting, in the configured grant resource, the energy request.
   4. The method of any of aspects 1-3, further comprising:

transmitting an indication of an energy harvesting time duration.

5. The method of any of aspects 1-4, further comprising:

determining the energy harvesting time duration based on at least one of an energy harvesting rate, a number of tasks, a reference transmit power, a channel parameter, or a radio frequency-to-energy conversion parameter.

6. The method of any of aspects 1-5, wherein the transmitting the indication of the energy harvesting time duration comprises:

transmitting an indication of a number of symbols.

7. The method of any of aspects 1-6, wherein a size of the one or more resources is based on the energy harvesting time duration.
8. The method of any of aspects 1-7, further comprising:

receiving a request for the indication of the energy harvesting time duration.

9. The method of any of aspects 1-8, wherein the transmitting the at least one of the energy request or the energy level indication comprises:

transmitting, to the second wireless communication device, the energy level indication indicating a low energy level satisfying a threshold, a low energy level failing to satisfy the threshold, a medium energy level, or a high energy level.

10. The method of any of aspects 1-9, further comprising:

entering a sleep mode after transmitting the at least one of the energy request or the energy level indication; and

detecting a wake-up signal (WUS) while in the sleep mode,

wherein the receiving the indication of the one or more resources is based on detecting the WUS.

11. A method of wireless communication performed by a first wireless communication device, the method comprising:

receiving, from a second wireless communication device, at least one of an energy request or an energy level indication;

transmitting, to the second wireless communication device in response to the at least one of the energy request or the energy level indication, an indication of one or more resources for transmitting a radio frequency (RF) energy harvesting signal; and

transmitting, to the second wireless communication device in the one or more resources, the RF energy harvesting signal.

12. The method of aspect 11, further comprising:

transmitting, to the second wireless communication device, a configuration for a user-assistance information signaling occasion,

wherein the receiving the at least one of the energy request or the energy level indication:
receiving, from the second wireless communication device during the user-assistance information signaling occasion, the energy request.
   13. The method of aspect 11, further comprising:

transmitting, to the second wireless communication device, a configuration for a configured grant resource,

wherein the receiving the at least one of the energy request or the energy level indication:
receiving, from the second wireless communication device in the configured grant resource, the energy request.
   14. The method of any of aspects 11-13, further comprising:

receiving, from the second wireless communication device, an indication of an energy harvesting time duration.

15. The method of any of aspects 11-14, wherein the energy harvesting time duration is based on at least one of an energy harvesting rate, a number of tasks, a reference transmit power, a channel parameter, or a radio frequency-to-energy conversion parameter.
16. The method of any of aspects 11-15, wherein the receiving the indication of the energy harvesting time duration comprises:

receiving an indication of a number of symbols.

17. The method of any of aspects 11-16, wherein a size of the one or more resources is based on the energy harvesting time duration.
18. The method of any of aspects 11-17, further comprising:

determining the size of the one or more resources based on at least one of the energy harvesting time duration or an energy harvesting unit resource.

19. The method of any of aspects 11-18, further comprising:

transmitting a request for the indication of the energy harvesting time duration.

20. The method of any of aspects 11-19, wherein the receiving the at least one of the energy request or the energy level indication comprises:

receiving, from the second wireless communication device, the energy level indication indicating a low energy level satisfying a threshold, a low energy level failing to satisfy the threshold, a medium energy level, or a high energy level.

21. The method of any of aspects 11-20, further comprising:

detecting the second wireless communication device is operating in a sleep mode; and

transmitting, to the second wireless communication device, a wake-up signal (WUS),

wherein the transmitting the indication of the one or more resources is based on the WUS.

22. The method of any of aspects 11-21, further comprising:

refraining, based on the at least one of the energy request or the energy level indication, from scheduling a communication with the second wireless communication device.

One aspect includes an apparatus comprising a processor coupled to a transceiver, wherein the processor and transceiver are configured to perform the method of any one of aspects 1-10.

Another aspect includes an apparatus comprising means for performing the method of any one of aspects 1-10.

Another aspect includes a non-transitory computer readable medium including program code, which when executed by one or more processors, causes a wireless communication device to perform the method of any one of aspects 1-10.

Another aspect includes an apparatus comprising a processor coupled to a transceiver, wherein the processor and transceiver are configured to perform the method of any one of aspects 11-22.

Another aspect includes an apparatus comprising means for performing the method of any one of aspects 11-22.

Another aspect includes a non-transitory computer readable medium including program code, which when executed by one or more processors, causes a wireless communication device to perform the method of any one of aspects 11-22.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

What is claimed is:

1. A method of wireless communication performed by a first wireless communication device, the method comprising:
transmitting, to a second wireless communication device, at least one of an energy request or an energy level indication;
receiving, from the second wireless communication device in response to the at least one of the energy request or the energy level indication, an indication of one or more resources for receiving a radio frequency (RF) energy harvesting signal;
receiving, from the second wireless communication device in the one or more resources, the RF energy harvesting signal; and
converting the RF energy harvesting signal to energy.

2. The method of claim 1, further comprising:
receiving a configuration for a user-assistance information signaling occasion,
wherein the transmitting the at least one of the energy request or the energy level indication comprises:
transmitting, during the user-assistance information signaling occasion, the energy request.

3. The method of claim 1, further comprising:
receiving a configuration for a configured grant resource,
wherein the transmitting the at least one of the energy request or the energy level indication comprises:
transmitting, in the configured grant resource, the energy request.

4. The method of claim 1, further comprising:
transmitting an indication of an energy harvesting time duration.

5. The method of claim 4, further comprising:
determining the energy harvesting time duration based on at least one of an energy harvesting rate, a number of tasks, a reference transmit power, a channel parameter, or a radio frequency-to-energy conversion parameter.

6. The method of claim 4, wherein the transmitting the indication of the energy harvesting time duration comprises:
transmitting an indication of a number of symbols.

7. The method of claim 4, wherein a size of the one or more resources is based on the energy harvesting time duration.

8. The method of claim 4, further comprising:
receiving a request for the indication of the energy harvesting time duration.

9. The method of claim 1, wherein the transmitting the at least one of the energy request or the energy level indication comprises:
transmitting, to the second wireless communication device, the energy level indication indicating a low energy level satisfying a threshold, a low energy level failing to satisfy the threshold, a medium energy level, or a high energy level.

10. The method of claim 1, further comprising:
entering a sleep mode after transmitting the at least one of the energy request or the energy level indication; and
detecting a wake-up signal (WUS) while in the sleep mode,
wherein the receiving the indication of the one or more resources is based on detecting the WUS.

11. A method of wireless communication performed by a first wireless communication device, the method comprising:
receiving, from a second wireless communication device, at least one of an energy request or an energy level indication;
transmitting, to the second wireless communication device in response to the at least one of the energy request or the energy level indication, an indication of one or more resources for transmitting a radio frequency (RF) energy harvesting signal; and
transmitting, to the second wireless communication device in the one or more resources, the RF energy harvesting signal.

12. The method of claim 11, further comprising:
transmitting, to the second wireless communication device, a configuration for a user-assistance information signaling occasion,
wherein the receiving the at least one of the energy request or the energy level indication:
receiving, from the second wireless communication device during the user-assistance information signaling occasion, the energy request.

13. The method of claim 11, further comprising:
transmitting, to the second wireless communication device, a configuration for a configured grant resource,
wherein the receiving the at least one of the energy request or the energy level indication:
receiving, from the second wireless communication device in the configured grant resource, the energy request.

14. The method of claim 11, further comprising:
receiving, from the second wireless communication device, an indication of an energy harvesting time duration.

15. The method of claim 14, wherein the energy harvesting time duration is based on at least one of an energy harvesting rate, a number of tasks, a reference transmit power, a channel parameter, or a radio frequency-to-energy conversion parameter.

16. The method of claim 14, wherein the receiving the indication of the energy harvesting time duration comprises:
receiving an indication of a number of symbols.

17. The method of claim 14, wherein a size of the one or more resources is based on the energy harvesting time duration.

18. The method of claim 17, further comprising:
determining the size of the one or more resources based on at least one of the energy harvesting time duration or an energy harvesting unit resource.

19. The method of claim 14, further comprising:
transmitting a request for the indication of the energy harvesting time duration.

20. The method of claim 11, wherein the receiving the at least one of the energy request or the energy level indication comprises:
receiving, from the second wireless communication device, the energy level indication indicating a low energy level satisfying a threshold, a low energy level failing to satisfy the threshold, a medium energy level, or a high energy level.

21. The method of claim 11, further comprising:
detecting the second wireless communication device is operating in a sleep mode; and
transmitting, to the second wireless communication device, a wake-up signal (WUS),
wherein the transmitting the indication of the one or more resources is based on the WUS.

22. The method of claim 11, further comprising:
refraining, based on the at least one of the energy request or the energy level indication, from scheduling a communication with the second wireless communication device.

23. A first wireless communication device comprising:
a memory;
a transceiver;
an energy harvester; and
at least one processor coupled to the memory, the transceiver, and the energy harvester, wherein first wireless communication device is configured to:
transmit, to a second wireless communication device via the transceiver, at least one of an energy request or an energy level indication;
receive, from the second wireless communication device via the transceiver in response to the at least one of the energy request or the energy level indication, an indication of one or more resources for receiving a radio frequency (RF) energy harvesting signal;
receive, from the second wireless communication device in the one or more resources via the transceiver, the RF energy harvesting signal; and
converting, via the energy harvester, the RF energy harvesting signal to energy.

24. The first wireless communication device of claim 23, wherein the first wireless communication device is further configured to:
determine an energy harvesting time duration based on at least one of an energy harvesting rate, a number of tasks, a reference transmit power, a channel parameter, or a radio frequency-to-energy conversion parameter; and
transmit, via the transceiver, an indication of the energy harvesting time duration.

25. The first wireless communication device of claim 24, wherein the first wireless communication device is further configured to:
receive a request for the indication of the energy harvesting time duration.

26. The first wireless communication device of claim 23, wherein the first wireless communication device is further configured to:
enter a sleep mode after transmitting the at least one of the energy request or the energy level indication; and
detect a wake-up signal (WUS) while in the sleep mode,
wherein the first wireless communication device is further configured to receive the indication of the one or more resources based on detecting the WUS.

27. A first wireless communication device comprising:
a memory;
a transceiver; and
at least one processor coupled to the memory and the transceiver, wherein first wireless communication device is configured to:
receive, from a second wireless communication device via the transceiver, at least one of an energy request or an energy level indication;
transmit, to the second wireless communication device via the transceiver in response to the at least one of the energy request or the energy level indication, an indication of one or more resources for transmitting a radio frequency (RF) energy harvesting signal; and
transmit, to the second wireless communication device in the one or more resources via the transceiver, the RF energy harvesting signal.

28. The first wireless communication device of claim 27, wherein the first wireless communication device is further configured to:
receive, from the second wireless communication device, an indication of an energy harvesting time duration, wherein the energy harvesting time duration is based on at least one of an energy harvesting rate, a number of tasks, a reference transmit power, a channel parameter, or a radio frequency-to-energy conversion parameter.

29. The first wireless communication device of claim 28, wherein the first wireless communication device is further configured to:
transmit a request for the indication of the energy harvesting time duration.

30. The first wireless communication device of claim 27, wherein the first wireless communication device is further configured to:
detect the second wireless communication device is operating in a sleep mode; and
transmit, to the second wireless communication device via the transceiver, a wake-up signal (WUS),
wherein the first wireless communication device is further configured to transmit the indication of the one or more resources is based on the WUS.
